(19) United States
(12) Patent Application Publication
(10) Pub. No.: US 2026/0292563 A1
(43) Pub. Date: Sep. 24, 2026

(54) METHODS FOR ACTIVATION OF LOW POWER TRANSMITTERS

(71) Applicant: InterDigital Patent Holdings, Inc., Wilmington, DE (US)

(72) Inventors: Young Woo KWAK, Woodbury, NY (US); Jongwoo HONG, New York, NY (US); Virgile GARCIA, Antibes (FR); Prasanna HERATH, Laval (CA); Moon IL LEE, Melville, NY (US)

(73) Assignee: InterDigital Patent Holdings, Inc., Wilmington, DE (US)

(21) Appl. No.: 19/088,566

(22) Filed: Mar. 24, 2025

(51) Int. Cl. H04W 24/10; H04B 7/06; H04L 5/00

(52) U.S. Cl. CPC H04W 24/10; H04B 7/0626; H04L 5/0051

(57) ABSTRACT

In some implementations, a WTRU may be configured with one or more low-power radios (LRs) and a main radio (MR). The WTRU may receive a measurement configuration including at least one of: one or more LR UL thresholds, one or more MR UL thresholds, one or more MR RSs, or one or more LR RSs. The WTRU may measure, using an activated receiver, one or more of the LR RSs or one of more the MR RSs. The WTRU may determine an UL transmission mode based on the measuring, where the UL transmission mode is one of a first LR UL transmission mode, a second LR UL transmission mode, or a MR UL transmission mode. The WTRU may receive configuration information include resources for each respective UL transmission mode. The WTRU may transmit an UL signal according to the determined UL transmission mode.

### BACKGROUND

In current and next generation wireless systems, low-power wake-up signal (LP-WUS) monitoring has the potential to reduce power consumption of UEs/WTRUs and other small battery powered devices. This is achieved by using a separate ultra-low power consumption receiver which can monitor wake-up signals (WUSs) and trigger the main radio (MR) dedicated for data and control signal transmission/reception. A LP-WUS allows a device in idle or inactive states to conserve battery life by reducing the need for continuous monitoring of control channels. These signals enable devices to transition from a low-power state to an active state only when necessary. A low power wake-up receiver (LR) is only capable of receiving LP-WUS from gNB. Therefore, in order to deliver any information to gNB, the device UE/WTRU needs to wake up the MR frequently, and the wake up reduces potential power saving gain from utilizing LP-WUS. Since LR may be a default feature in 6G for all devices, UE/WTRUs, more efficient operation is required for several operations, for example as initial access.

A UE or WTRU may be equipped with multiple UL transmission types. However, LR based UL transmission types support lower coverage than MR and higher complexity LR based UL transmission. For example, a low complexity LR may have less UL coverage than a high complexity LR, which may have less UL coverage than a MR. Thus, the need exists for a technological solution to support efficient UL transmission according the radio type.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

This disclosure relates to communication networks. One or more embodiments disclosed herein are related to methods and apparatus for enhancement of low-power wake-up signals (LP-WUSs), for example, by activation of low-power transmissions in wireless communications.

In one general aspect, a method may include receiving a measurement configuration including at least one of: one or more low-power radio (LR) UL thresholds, one or more main radio (MR) UL thresholds, one or more MR reference signals (RSs), or one or more LR RSs. The method may also include measuring one or more of the LR RSs or one of more the MR RSs based on an activated receiver. The method may furthermore include determining an UL transmission mode based on the measuring, where the UL transmission mode is one of a first LR UL transmission mode, a second LR UL transmission mode, or a MR UL transmission mode. The method may in addition include transmitting an UL signal according to the determined UL transmission mode. Other embodiments of this aspect include corresponding computer systems, apparatus, and computer programs recorded on one or more computer storage devices, each configured to perform the actions of the methods.

Implementations may include one or more of the following features. The method may include: receiving at least one of: first configured resources for the first LR UL transmission mode; second configured resources for the second LR UL transmission mode; or third configured resources for the MR UL transmission mode. The method may include: determining a type of channel state information (CSI) based on the UL signal transmitted. The method may include: measuring the one or more LR RSs when the transmitted UL signal may include the first LR UL transmission mode or the second LR UL transmission mode; and reporting CSI change information, where the CSI change information is one of: no change, a change less than a first CSI threshold, a change less than a second CSI threshold, or a change more than the second CSI threshold. The method may include reporting the CSI change information based on on-off keying or binary phase shift keying (BPSK) by reflecting one or more of the first configured resources when the UL signal is transmitted via the first LR UL transmission mode. The method may include: transmitting a sequence using an UL resource of the second configured resources to report the CSI change information when the UL signal is transmitted via the second LR UL transmission mode. The method may include: determining a DL signal quality based on the measuring. The method may include: determining the UL transmission mode is the first LR UL transmission mode when the determined DL signal quality is equal to or greater than a first LR UL threshold of the one or more LR UL thresholds; determining the UL transmission mode is the second LR UL transmission mode when the determined DL signal quality is equal to or greater than a second LR UL threshold of the one or more LR thresholds, where the first LR UL threshold is greater than the second LR UL threshold; and determining the UL transmission mode is the MR UL transmission mode when the determined DL signal quality is equal to or less than the second LR UL threshold. The method where the one or more MR RSs include at least one of a synchronization signal block (SSB) or channel state information reference signal (CSI-RS), and where the one or more LR RSs include at least one of a low-power synchronization signal (LP-SS) or an on-off key (OOK) based signal. The method where the UL signal is transmitted within an activation window associated with the determined UL transmission mode. Implementations of the described techniques may include hardware, a method or process, or a computer tangible medium.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 an illustration of simplified receiver architecture of a WTRU utilizing a low-power wake-up receiver;

FIG. 3A illustrates a LR with no energy storage and no independent signal generation/amplification;

FIG. 3B illustrates a LR with energy storage and no independent signal generation/amplification;

FIG. 3C illustrates a LR with energy storage and independent signal generation;

FIG. 4 is an illustration of an example idle mode wake-up signal monitoring;

FIG. 5A illustrates WTRU power consumption in 3GPP Rel-16 ;

FIG. 5B illustrates WTRU power consumption in 3GPP Rel-17 using PEI;

FIG. 5C illustrates WTRU power consumption in 3GPP Rel-17 using PEI and TRS; and

FIG. 6 is a flow diagram of an example process for choosing an UL transmitter and an UL transmission mode.

### DETAILED DESCRIPTION

Abbreviations and Acronyms
Δf Sub-carrier spacing
gNB NR NodeB
ACK Acknowledgement
AP Aperiodic
BFR Beam Failure Recovery
BFD-RS Beam Failure Detection-Reference Signal
BLER Block Error Rate
BWP Bandwidth Part
CA Carrier Aggregation
CAPC Channel access priority class
CB Contention-Based (e.g. access, channel, resource)
CCA Clear Channel Assessment
CCE Control Channel Element
CDM Code Division Multiplexing
CE Control Element
CG Configured grant or cell group
CLI Cross-Link Interference
CoMP Coordinated Multi-Point transmission/reception
COT Channel Occupancy Time
CP Cyclic Prefix
CPE Common Phase Error
CP-OFDM Conventional OFDM (relying on cyclic prefix)
CQI Channel Quality Indicator
CMAS Commercial Mobile Alert System
CN Core Network (e.g. LTE packet core or NR core)
CRC Cyclic Redundancy Check
CSI Channel State Information
CSI-RS Channel State Information-Reference Signal
CU Central Unit
CW Contention Window
CWS Contention Window Size
CO Channel Occupancy
D2D Device to Device transmissions (e.g. LTE Sidelink)
DAI Downlink Assignment Index
DC Dual Connectivity
DCI Downlink Control Information
DFI Downlink feedback information
DG Dynamic grant
DL Downlink
DM-RS Demodulation Reference Signal
DRB Data Radio Bearer
DRX Discontinuous reception
DU Distributed Unit
EN-DC E-UTRA—NR Dual Connectivity
EPC Evolved Packet Core
ETWS Earthquake and Tsunami Warning Service
FD-CDM Frequency Domain-Code Division Multiplexing
FDD Frequency Division Duplexing
FDM Frequency Division Multiplexing
FSK Frequency Shift Keying
HARQ Hybrid Automatic Repeat Request
ICI Inter-Cell Interference
ICIC Inter-Cell Interference Cancellation
IP Internet Protocol
LAA License Assisted Access
LBT Listen-Before-Talk
LCH Logical Channel
LCID Logical Channel Identity
LCP Logical Channel Prioritization
LLC Low Latency Communications
LO LP-WUS Occasion
LP-WUS Low Power Wake-Up Signal
LP-WUR Low Power Wake-Up Receiver
LTE Long Term Evolution e.g. from 3GPP LTE R8 and up
MA Medium Access Control
MAC CE Medium Access Control Control Element
NACK Negative ACK
MBM Multimedia Broadcast Multicast System
MCG Master Cell Group
MCS Modulation and Coding Scheme
MIMO Multiple Input Multiple Output
MO LP-WUS Monitoring Occasion
MR Main Radio
MTC Machine-Type Communications
MR-DC Multi-RAT Dual Connectivity
NAS Non-Access Stratum
NCB-RS New candidate beam-Reference Signal
NE-DC NR-RAN-E-UTRA Dual Connectivity
NR New Radio
NR-DC Dual Connectivity with
OCC Orthogonal Cover Code
OFDM Orthogonal Frequency-Division Multiplexing
OFDMA Orthogonal Frequency-Division Multiple Access
OOB Out-Of-Band (emissions)
OOK On Off Keying
P_{cmax} Total available UE power in a given transmission interval
PCell Primary cell of Master Cell Group
PCG Primary Cell Group
PDU Protocol Data Unit
PEI Paging Early Indication
PER Packet Error Rate
PHY Physical Layer
PLMN Public Land Mobile Network
PLR Packet Loss Rate
PO Paging Occasion
PRACH Physical Random-Access Channel
PRB Physical Resource Block
PRI PUCCH Resource Indicator
PRS Positioning Reference Signal
PSCell Primary cell of a Secondary cell group
PSS Primary Synchronization Signal
PT-RS Phase Tracking-Reference Signal
QoS Quality of Service (from the physical layer perspective)
RAB Radio Access Bearer
RAN PA Radio Access Network Paging Area
RACH Random Access Channel (or procedure)
RAR Random Access Response
RAT Radio Access Technology
RB Resource Block
RCU Radio access network Central Unit
RF Radio Front end
RE Resource Element
RLF Radio Link Failure
RLM Radio Link Monitoring
RNTI Radio Network Identifier
RO Random Access Occasion
ROM Read-Only Mode (for MBMS)
RRC Radio Resource Control
RRM Radio Resource Management
RS Reference Signal
RSRP Reference Signal Received Power
RSRQ Reference Signal Received Quality
RTT Round-Trip Time
SBFD Subband non-overlapping full duplex
SCG Secondary Cell Group
SCMA Single Carrier Multiple Access
SCS Sub-Carrier Spacing
SDU Service Data Unit
SIB System Information Block
SOM Spectrum Operation Mode
SP Semi-persistent
SpCell Primary cell of a master or secondary cell group.
SRB Signaling Radio Bearer
SS Synchronization Signal
SRS Sounding Reference Signal
SSS Secondary Synchronization Signal
SUL Supplementary Uplink
SWG Switching Gap (in a self-contained subframe)
TB Transport Block
TBS Transport Block Size
TCI Transmission Configuration Index
TDD Time-Division Duplexing
TDM Time-Division Multiplexing
TI Time Interval (in integer multiple of one or more symbols)
TTI Transmission Time Interval (in integer multiple of one or more symbols)
TRP Transmission/Reception Point
TRPG Transmission/Reception Point Group
TRS Tracking Reference Signal
TRx Transceiver
UL Uplink
URC Ultra-Reliable Communications
URLLC Ultra-Reliable and Low Latency Communications
V2X Vehicular communications
WLAN Wireless Local Area Networks and related technologies (IEEE 802.xx domain)
WUS Wake-up signal
XDD Cross Division Duplex

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Communications Networks and Devices

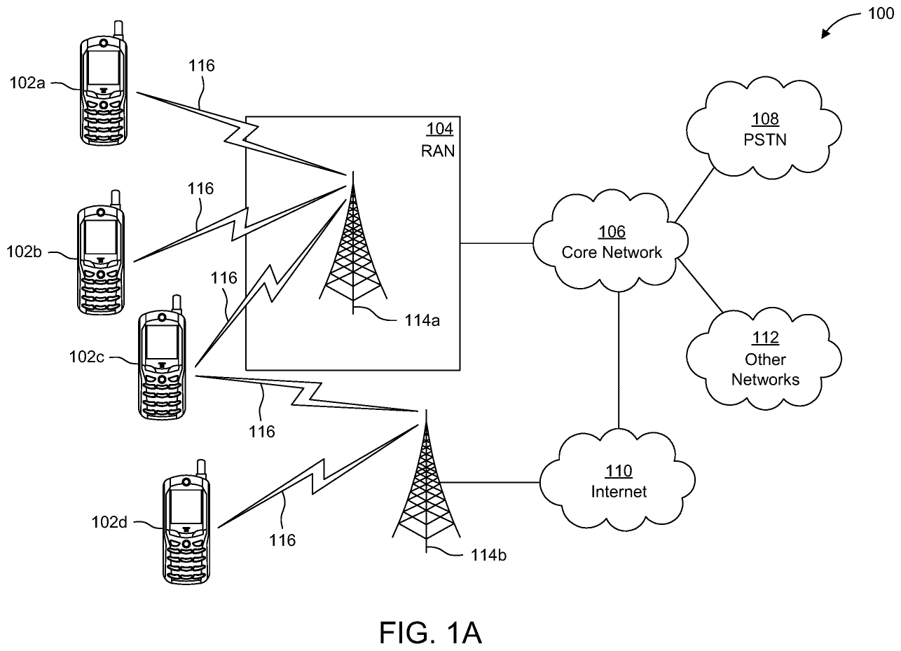

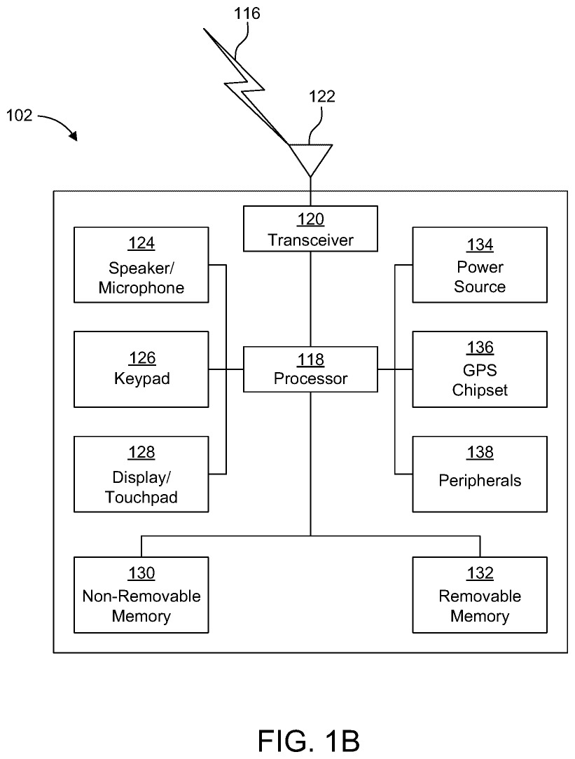

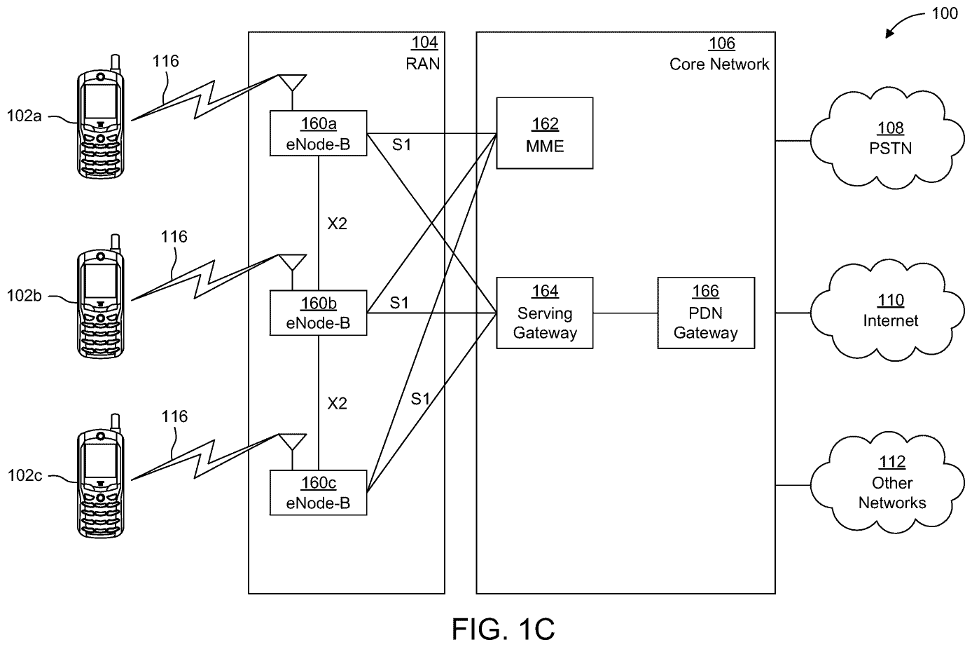

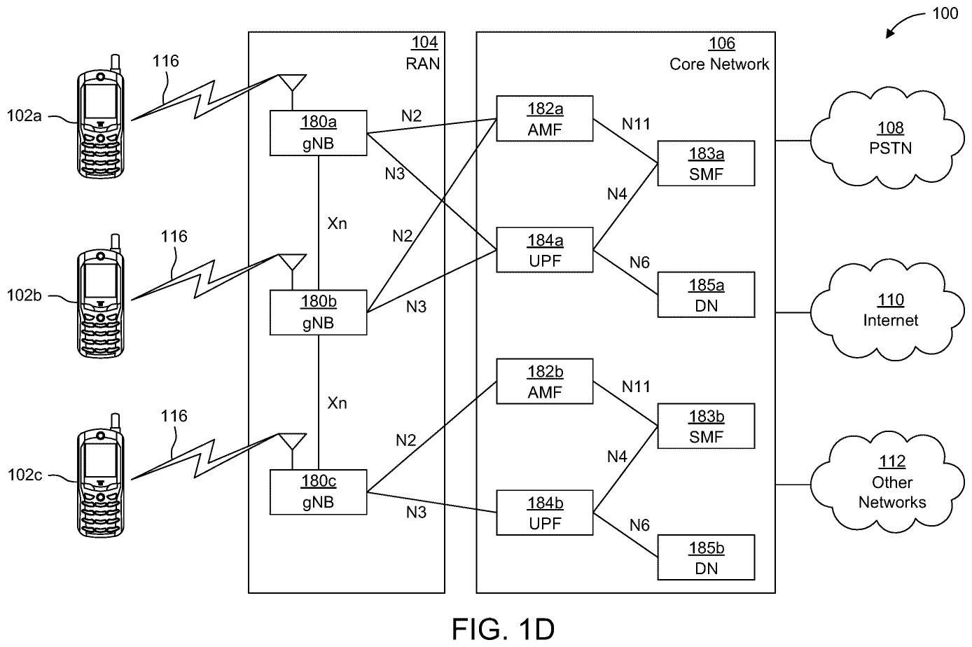

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102 c, 102 d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

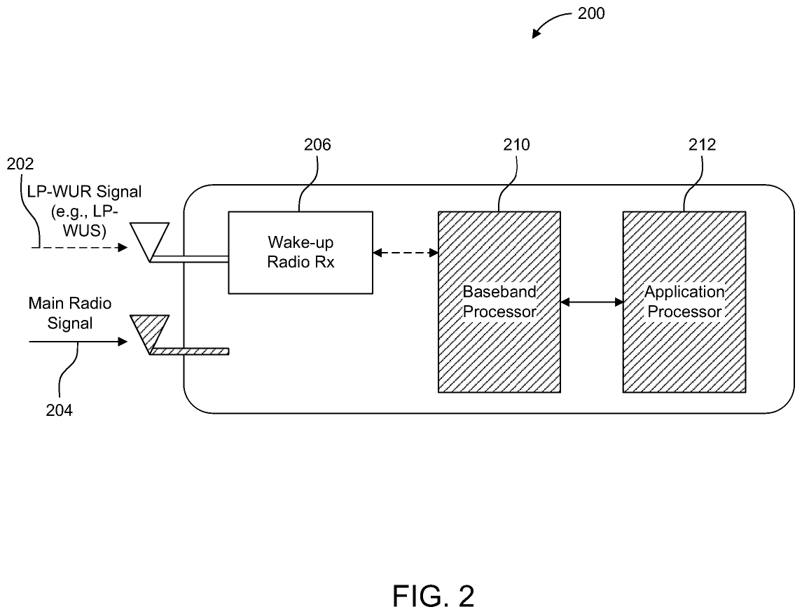

FIG. 2 illustrates a simplified receiver architecture 200 of a WTRU (e.g. WTRU 102) utilizing a low-power wake-up receiver. Low power-wake up signal (LP-WUS) monitoring has the potential to reduce power consumption of UEs and other small battery powered devices. This is achieved by using a separate ultra-low power consumption receiver which can monitor wake-up signals (WUSs) and trigger the main radio (MR) dedicated for data and control signal transmission/reception as shown in FIG. 2. A LP-WUS 202 may be received by LR 206. The low-power signal may be received while a WTRU is in a low-power state and used to wake-up the main radio. LP-WUS 202 may be processed by baseband processor 210 and application processor 212. Signal processing of the LP-WUS is performed to reliably obtain determine that the signal is intended for the device and the signal is a wake-up signal. Application processor 212 may trigger baseband processor 210 to wake-up MR 208. Based on the processing of LP-WUS 202 by baseband processor 210 and application processor 212, MR 208 is triggered to wake-up or turn on MR 208. MR 208 may then transmit and receive main radio signal 204. For example, a WTRU may have MR 208 turned off to reduce power consumption. Upon receiving LP-WUS 202, LR 206 may trigger MR 208 to wake-up and start monitoring a channel of a wireless network. For example, MR 208 may start to monitor a physical downlink control signal (PDCCH), listen for paging occasion, and transition from an idle or inactive mode to an active mode.

In Ambient IoT discussions, the three device types have been identified: Device A, Device B, and Device C. Device A does not have energy storage, nor independent signal generation/amplification. Device B has energy storage that may be used for amplification of reflected signals but no independent signal generation, i.e. backscattering transmission. Device C has energy storage, has independent signal generation, i.e., active RF components for transmission. Device C may support backscattering.

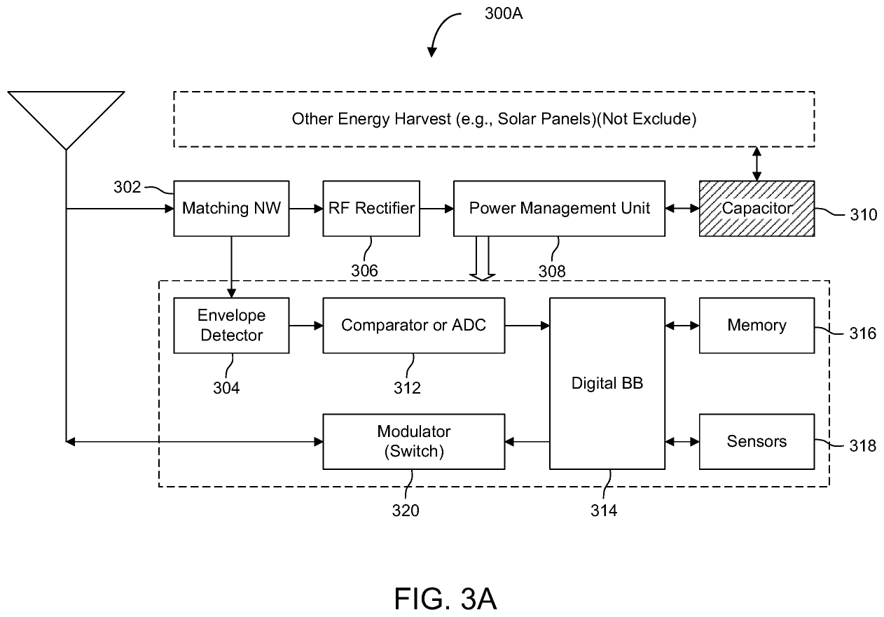

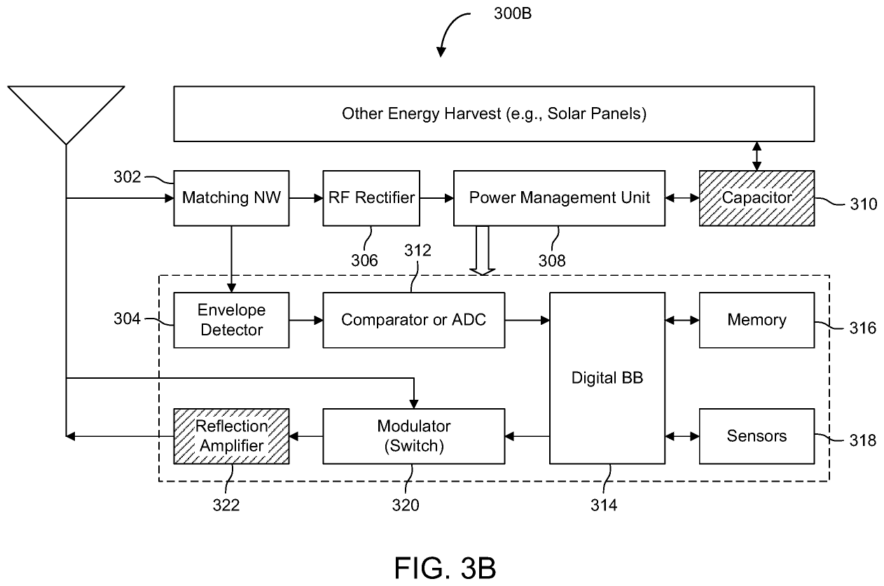

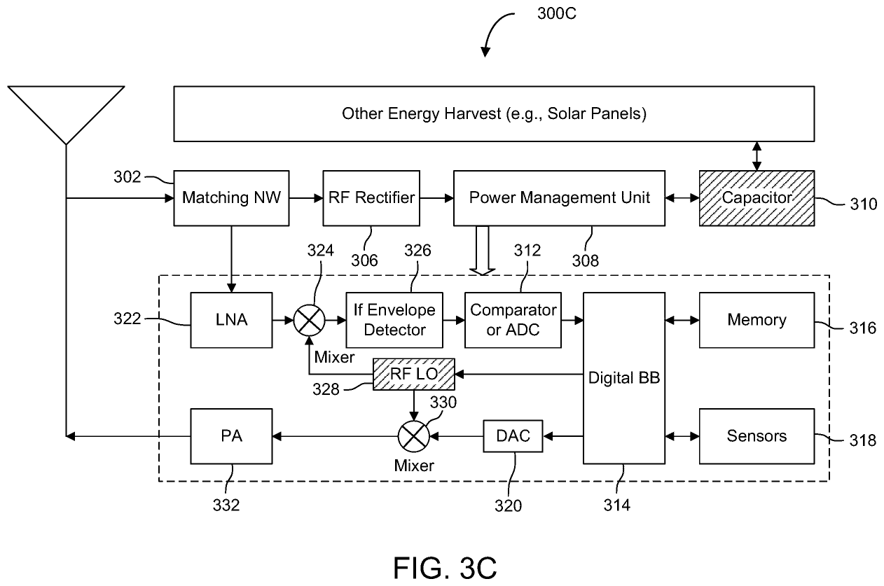

FIG. 3A illustrates a low complexity LR that does not have energy storage capability nor independent signal generation/amplification capability. 300A may be viewed as a passive device with backscattering transmission. A signal detected at an antenna may be input to a matching network (Matching NW 302) which may match the antenna impedance to the chip/circuit impedance. The signal is then input to RF rectifier 306 and envelope detector 304. RF rectifier may convert incoming RF energy into usable DC power. Power management unite 308 receives an input from RF rectifier 306 and is coupled to capacitor 310a. Capacitor 310a may be needed as low level signal may not effectively power the chip during the reception phase. The impedance matched chip/circuit 322 may include envelope detector 304, comparator or analog-to digital convertor (ADC) 312, digital baseband processor 314, memory 316, sensors 318 and modulator (or switch in the case of on-off keying) 320.

FIG. 3B illustrates a LR with energy storage and no independent signal generation/amplification. Device B illustrated in FIG. 3B may have better performance and larger coverage than 300A. For brevity, the description of elements common to Device A are not repeated. The main differences between 300A and 300B are the larger capacitor, capacitor 310b, and reflection amplifier 324. In Device B, capacitor 310b provides energy storage which may offer improved receiver sensitivity. Reflection amplifier 324 amplify the weak backscattered signal. Thus, 300A may have better coverage compared to 300A. As an example, reflection amplifier 324 may use a tunnel diode or other negative resistance devices to amplify the reflected signal.

FIG. 3C illustrates a LR with energy storage and independent signal generation. 300C may include a local oscillator and mixer. As illustrated in FIGS. 3, 300C has active RF and supports backscattering. For brevity, the description of elements common to Device A are not repeated. Capacitor 310c has a larger capacity than capacitors 310a and 310b. Matching NW 302 may match the antenna impedance to the impedance of chip/circuit 304. Low noise amplifier (LNA) 322 may amplifying weak signals from the antenna while minimizing noise. LNA 322 is coupled with mixer 324. The receive signal chain includes IF envelope detector 326, comparator 312, digital baseband (BB) processor 314, memory 316 and sensors 318. Input to RF local oscillator (RF LO) 328 and digital-to-analog convertor (DAC) 320 is provided by Digital BB 314. RF LO 328 provides an input to mixer 324 and mixer 330. Mixer 330 provides an input to power amplifier (PA) 332. PA 322 provides amplification for the transmitted signal.

In 3GPP Rel-18/19 , a Low power wake-up Receiver (LR) is only capable of receiving LP-WUS from gNB. Therefore, in order to deliver any information to gNB, the WTRU needs to wake up MR frequently and the wake up reduces potential power saving gain from utilizing LP-WUS. As LR may be a default feature in 6G for all the WTRUs, more efficient operation is required including other operations such as initial access, support of UL should be considered.

WTRU may be equipped with multiple UL transmission types. Three example devices, Device A, Device B, and Device C are described above. However, LR based UL transmission types support lower coverage than MR, and lower complexity LR based UL transmission support lower coverage than higher complexity LR based UL transmission. For example, coverage may be Device A UL<Device B UL<Device C UL. That is, OOK based LR<OFDM based LR<MR.

In an example embodiment, a WTRU may receive configuration information, the configuration may be received via SIB and/or RRC, for example. The WTRU may receive measurement related configurations including one or more LR measurement thresholds for determining an UL transmission mode (e.g., a first UL threshold and a second UL threshold where, the first UL threshold >the second UL threshold), one or more MR measurement thresholds for determining the UL transmission mode, one or more RSs for MR (e.g., SSBs), and one or more RSs for LR (e.g., LP-SSs)

Configuration information may also include resources for a first (e.g., low complexity) LP UL transmission mode (e.g., based on back scattering), resources for a second (e.g., high complexity) LP UL transmission mode (e.g., sequence based), and resources for a MR based UL transmission mode.

The WTRU may be configured to measure one or more RSs according to the activated receiver. For example, if the WTRU activated LR, the WTRU measures the one or more RSs for LR. In another example, if the WTRU activated the MR, the WTRU measures the one or more RSs for MR.

The WTRU may be configured to determine an UL transmission mode based on the measurements. The determination of the UL transmission mode may be as follows: if the DL measured quality >the first UL threshold, the WTRU determines the first LP UL transmission mode; if the DL measured quality >the second UL threshold, the WTRU determines the second LP UL transmission mode; and if the DL measured quality <the second UL threshold, the WTRU determines MR based UL transmission mode.

The WTRU may be configured to activate the determined UL transmission mode. The WTRU may activate the indicated UL transmission mode within an activation window associated with the activated UL transmission mode. Optionally, the WTRU may indicate the determined UL transmission mode (e.g., to the gNB). For example, if the first LP UL transmission mode is used or determined, the WTRU reflects all or a subset (e.g., associated with the transmitter and/or a best beam) of the one or more RSs for LR.

The WTRU may be configured to support WTRU operation based on a type of the activated UL transmission mode. For example, if the WTRU activates the first or the second LP UL transmission mode, the WTRU measures one or more RSs for LR (e.g., LP-SS) and reports CSI change, where the CSI change is reported as one or more of the following: no information change; information change less than a first CSI threshold; information change less than a second CSI threshold; or information change more than the second CSI threshold.

In a case where the WTRU activates the first LP UL transmission mode, the WTRU reports the CSI change based on OOK or BPSK by reflecting the one or more RSs for LR. In a case where the WTRU may activate the second LP UL transmission mode, the WTRU may report the CSI change by transmitting a sequence in an UL resource of the one or more UL resources, wherein the sequence and/or the UL resource are associated with the CSI.

For the case of information change more than the second CSI threshold, the WTRU may activate MR based UL transmission mode after an associated activation time from sending the indication. For example, the WTRU measures one or more RSs associated with MR (e.g., SSB) and reports CSI in UL resources for MR (e.g., within DRX on duration).

A WTRU may transmit or receive a physical channel or reference signal according to at least one spatial domain filter. The term “beam” may be used to refer to a spatial domain filter.

The WTRU may transmit a physical channel or signal using the same spatial domain filter as the spatial domain filter used for receiving a RS (such as CSI-RS) or a SS block. The WTRU transmission may be referred to as “target,” and the received RS or SS block may be referred to as “reference” or “source.” In such case, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (target) physical channel or signal according to a spatial relation with a reference to the second (reference) physical channel or signal.

A spatial relation may be implicit, configured by RRC or signaled by MAC CE or DCI. For example, a WTRU may implicitly transmit PUSCH and DM-RS of PUSCH according to the same spatial domain filter as an SRS indicated by an SRI indicated in DCI or configured by RRC. In another example, a spatial relation may be configured by RRC for an SRS resource indicator (SRI) or signaled by MAC CE for a PUCCH. Such spatial relation may also be referred to as a “beam indication.”

The WTRU may receive a first (target) downlink channel or signal according to the same spatial domain filter or spatial reception parameter as a second (reference) downlink channel or signal. For example, such association may exist between a physical channel such as PDCCH or PDSCH and its respective DM-RS. At least when the first and second signals are reference signals, such association may exist when the WTRU is configured with a quasi-colocation (QCL) assumption type D between corresponding antenna ports. Such association may be configured as a TCI (transmission configuration indicator) state. A WTRU may be indicated an association between a CSI-RS or SS block and a DM-RS by an index to a set of TCI states configured by RRC and/or signaled by MAC CE. Such indication may also be referred to as a “beam indication.”

The WTRU may use Discontinuous Reception (DRX) in RRC_IDLE and RRC_INACTIVE state in order to reduce power consumption. The WTRU monitors one paging occasion (PO) per DRX cycle. A PO is a set of PDCCH monitoring occasions and can consist of multiple time slots (e.g. subframe or OFDM symbol) where paging DCI can be sent. One Paging Frame (PF) is one Radio Frame and may contain one or multiple PO(s) or starting point of a PO.

In multi-beam operations, the WTRU assumes that the same paging message and the same Short Message are repeated in all transmitted beams and thus the selection of the beam(s) for the reception of the paging message and Short Message is up to WTRU implementation. The paging message is same for both RAN initiated paging and CN initiated paging.

The WTRU initiates RRC Connection Resume procedure upon receiving RAN initiated paging. If the WTRU receives a CN initiated paging in RRC_INACTIVE state, the WTRU moves to RRC_IDLE and informs NAS.

When SearchSpaceId other than 0 is configured for pagingSearchSpace, the WTRU monitors the (i_s+1)th PO. A PO is a set of ‘S*X ’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. The [x*S+K]th PDCCH monitoring occasion for paging in the PO corresponds to the Kth transmitted SSB, where x=0,1,..., X-1, K=1,2,..., S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDCCH-MonitoringOccasionOfPO is present, the starting PDCCH monitoring occasion number of (i_s+1)th PO is the (i_s+1)th valWTRU of the firstPDCCH-MonitoringOccasionOfPO parameter; otherwise, it is equal to i_s*S*X. If X>1, when the WTRU detects a PDCCH transmission addressed to P-RNTI within its PO, the WTRU is not required to monitor the subsequent PDCCH monitoring occasions for this PO.

The following parameters are used for the calculation of PF and i_s above.
T: DRX cycle of the WTRU (T is determined by the shortest of the WTRU specific DRX value(s), if configured by RRC and/or upper layers, and a default DRX value broadcast in system information. In RRC_IDLE state, if WTRU specific DRX is not configured by upper layers, the default value is applied).
N: number of total paging frames in T
Ns: number of paging occasions for a PF
PF_offset: offset used for PF determination
UE_ID: 5G-S-TMSI mod 1024

Parameters Ns, nAndPagingFrameOffset, nrofPDCCH-MonitoringOccasionPerSSB-InPO, and the length of default DRX Cycle are signaled in SIB1. The values of N and PF_offset are derived from the parameter nAndPagingFrameOffset. The parameter first-PDCCH-MonitoringOccasionOfPO is signaled in SIB1 for paging in initial DL BWP. For paging in a DL BWP other than the initial DL BWP, the parameter first-PDCCH-MonitoringOccasionOfPO is signaled in the corresponding BWP configuration.

If the WTRU has no 5G-S-TMSI, for instance when the WTRU has not yet registered onto the network, the UE shall use as default identity UE_ID=0 in the PF and i_s formulas above.

A WTRU may monitor for or listen to the paging message to know about one or more of incoming calls, system information change, ETWS (Earthquake and Tsunami Warning Service) notification for ETWS capable WTRUs, CMAS (Commercial Mobile Alert System) notification and Extended Access Barring parameters modification.

In RRC Idle state, the WTRU monitors Short Messages transmitted with paging RNTI (P-RNTI) over DCI and monitors a Paging channel for CN paging using 5G-S-TMSI. In RRC Inactive state, the WTRU monitors Short Messages transmitted with P-RNTI over DCI and monitors a Paging channel for CN paging using 5G-S-TMSI and RAN paging using fullI-RNTI. In RRC Connected state, a WTRU may monitor Short Messages transmitted with P-RNTI over DCI.

In 3GPP Rel-15 , a wake-up signal for Idle mode paging was introduced for WTRUs supporting NB-IoT or eMTC. Similar to the concept described above for connected mode, the WTRU monitors for a wake-up signal at a time specified by T_gap before the paging occasion. If the WTRU receives an indication that there may be paging addressed to that WTRU in the next paging time window then the WTRU monitors PDCCH during each paging occasion of that paging time window. The paging time window is defined such that WTRUs with a very long DRX in the order of minutes (eDRX) and which may suffer from clock drift compared to the network timing may reliably receive paging.

FIG. 4 illustrates of an example idle mode wake-up signal monitoring in 3GPP Rel-15 .

In 3GPP Rel-15 , a wake-up signal for Idle mode paging was introduced for WTRUs supporting NB-IoT or eMTC. Similar to the concept described above for connected mode, the WTRU monitors for a wake-up signal 402 at a time specified by T_gap 406 before the paging occasion 410. If the WTRU receives an indication that there may be paging addressed to that WTRU in the next paging time window then the WTRU monitors PDCCH during each paging occasion of that paging time window. The paging time window is defined such that WTRUs with a very long DRX 408 in the order of minutes (eDRX) and which may suffer from clock drift compared to the network timing may reliably receive paging. The WTRU will wake-up upon receiving wake-up signal 404.

In 3GPP Rel-17 , a wake-up signal for Idle mode paging was discussed. A paging early indication (PEI) in DCI format 2-7 transmitted prior to the WTRU paging occasion will indicate whether the WTRU has to monitor PDCCH and potentially PDSCH to receive a paging message. PEI also includes paging indication which indicates WTRU subgroups in one or more paging occasions to be used for paging and TRS availability indication for acquiring time/frequency synchronization for paging.

In Rel-16, the WTRU had wake up to measure SS burst for time/frequency synchronization and monitor paging occasions (POs), however, in Rel-17, the WTRU can maintain deep sleep if the WTRU does not receive PEI. In addition, if the WTRU receive PEI, the WTRU can wake up, measure TRS burst and receive POs. Another benefit of PEI is that the WTRU does not need to periodically wake up to maintain time/frequency synchronization for PO reception as PEI is able to indicate TRS burst for acquiring time/frequency synchronization.

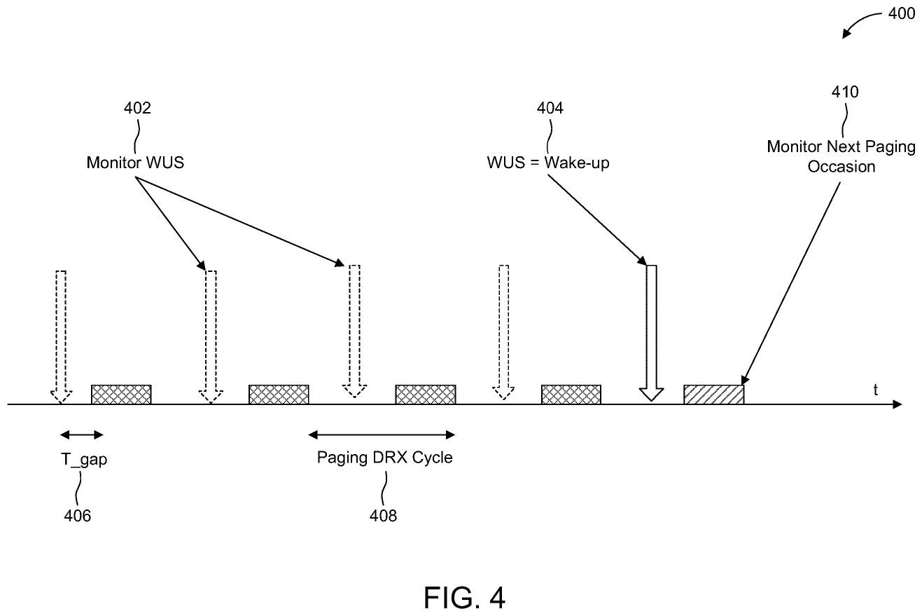

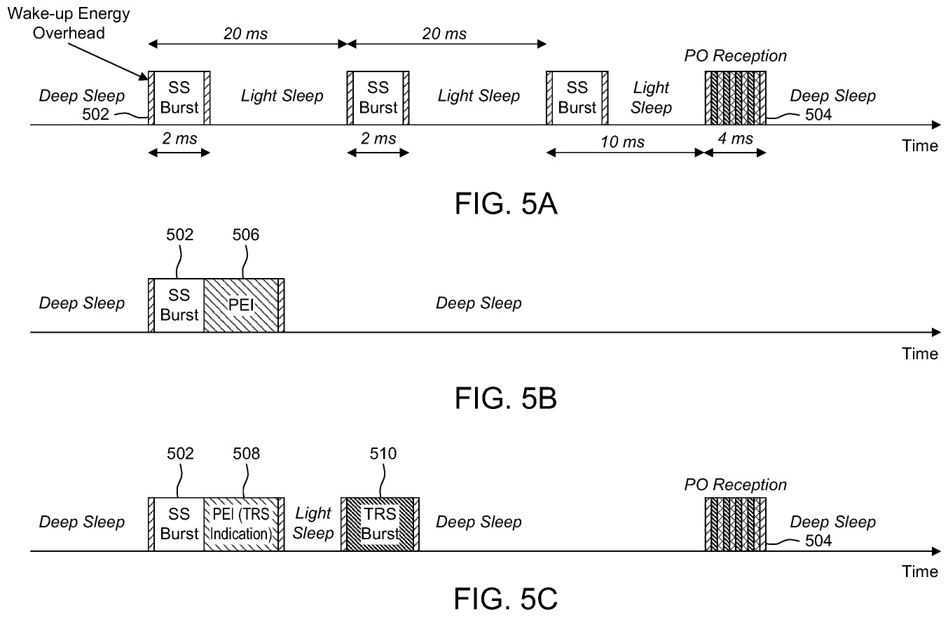

FIG. 5A illustrates WTRU power consumption in 3GPP Rel-16 .

In 3GPP Rel-16 , the WTRU had to wake-up to measure SS burst 502 for time/frequency synchronization and monitor paging occasions (POs) 504, however, in Rel-17, the WTRU can maintain deep sleep if the WTRU does not receive PEI. In addition, if the WTRU receives PEI, the WTRU can wake up, measure a TRS burst and receive POs. Another benefit of PEI is that the WTRU does not need to periodically wake up to maintain time/frequency synchronization for PO reception as PEI is able to indicate a TRS burst for acquiring time/frequency synchronization.

FIG. 5B illustrates WTRU power consumption in 3GPP Rel- 17 using PEI.

In 3GPP Rel-17 , a wake-up signal for Idle mode paging was discussed. A paging early indication (PEI) 506 in DCI format 2-7 transmitted prior to the WTRU paging occasion will indicate whether the WTRU has to monitor PDCCH and potentially PDSCH to receive a paging message.

FIG. 5C illustrates WTRU power consumption in 3 GPP Rel-17 using PEI and TRS.

PEI also includes paging indication which indicates WTRU subgroups in one or more paging occasions to be used for paging and tracking reference signal (TRS) availability indication for acquiring time/frequency synchronization for paging. As illustrated in FIG. 5C, SS Burst 502 is followed by PEI with TRS indication 508. TRS 510 helps the WTRU synchronize with the network.

Hereafter, LP-WUS occasion (LO) may be interchangeably used with LP-WUS monitoring occasion (MO) consistent with the description.

In an example embodiment, a WTRU may receive one or more configurations/information. The configurations/information may be delivered via one or more of SIB (e.g., SIB1), RRC and MAC CE. The one or more of configurations/information may be one or more of: configurations for monitoring LP-WUS, paging, and PEI.

Configuration information may include WTRU/UE ID. In an example embodiment, the WTRU may receive UE ID. For example, 5G-S-TMSI mod 1024 may be used as a UE ID.

Configuration information may include paging related configurations. In an example, the WTRU may receive information nAndPagingFrameOffset. Based on the received information, the WTRU may determine one or more of the Number of total paging frames (N) or Paging frame offset (PF_offset).

In an example, the WTRU may receive/determine the information on number of total paging frames (N) (e.g., via nAndPagingFrameOffset). Candidate values for the number of total paging frames may be different for different serving cell SSB periodicity. In another example, the WTRU may receive/determine the information on paging frame offset (e.g., via nAndPagingFrameOffset).

Configuration information may include DRX cycle (T). In an example, the WTRU may receive information of DRX cycle of the WTRU (T is determined by the shortest of the WTRU specific DRX value(s), if configured by RRC and/or upper layers, and a default DRX value broadcast in system information. In another example, the WTRU may use a default value (e.g., In RRC_IDLE state, if WTRU specific DRX is not configured by upper layers, the default value is applied).

Configuration information may include number of paging occasions (e.g., for a PF) (Ns). In an example, the WTRU may receive information of number of paging occasions (e.g., per PF) for paging operation. For example, the WTRU may receive one of 1, 2 or 4 paging occasions for paging operation.

Configuration information may include PEI related configurations may include one or more of the following.

Search space set (e.g., by pei-SearchSpace); in an example, the WTRU may receive information of one or more search space sets (e.g., to monitor PDCCH for detection of DCI format 2_7 according to a Type2A-PDCCH CSS set).

Number of paging occasions in PEI (e.g., N_PO\hat{ }PEI); in an example, the WTRU may receive information of number of paging occasions supported by PEI. For example, one of 1, 2, 4 or 8 may be indicated.

PEI payload size (e.g., by payloadSizeDCI-2-7); in an example, the WTRU may receive information of PEI payload size. For example, up to 41 bits and 43 bits for licensed and unlicensed spectrums, respectively, may be indicated.

PEI frame offset (e.g., by pei-FrameOffset); in an example, the WTRU may receive frame offset for PEI. For example, the WTRU may receive offset from the start of a reference frame for PEI-O (e.g., the start of a frame) to the start of a first paging frame of the paging frames associated with a number of PDCCH monitoring occasions for DCI format 2_7.

PEI symbol offset (e.g., for PEI by firstPDCCH-MonitoringOccasionOfPEI-O); in an example, the WTRU may receive symbol offset for PEI. For example, the WTRU may receive offset (e.g., in number of symbols) from the start of the frame to the start of the first PDCCH monitoring occasion for DCI format 2_7.

Number of subgroups (e.g., N _SG\hat{ }PO for PEI); in an example, the WTRU may receive information of total number of subgroups (e.g., for PEI). For example, the WTRU may receive one or both of subgroupsNumPerPO and subgroupsNumForUEID. Based on the received information, the WTRU may determine whether to use UE ID based subgrouping or CN based subgrouping. For example, one or more of the following may be used: in an example, if subgroupsNumForUEID is absent in subgroupConfig, the subgroup ID based on CN assigned subgrouping, if available for the WTRU, may be used; in an example, if both subgroupsNumPerPO and subgroupsNumForUEID are configured, and subgroupsNumForUEID has the same value as subgroupsNumPerPO, the subgroup ID based on UE_ID based subgroupingmay be used in the cell; and in an example, if both subgroupsNumPerPO and subgroupsNumForUEID are configured, and subgroupsNumForUEID<subgroupsNumPerPO. The subgroup ID based on CN assigned subgrouping, if available for the WTRU, may be used in the cell; otherwise, the subgroup ID based on UE_ID based subgrouping may be used in the cell; and if the WTRU has no CN assigned subgroup ID or does not support CN assigned subgrouping, and there is no configuration for subgroupsNumForUEID, the WTRU may monitors the associated PO.

Configurations for LP-WUS; LP-WUS occasions; (LOs) and LP-WUS monitoring occasions (MOs). In an example, the WTRU may receive configurations of LOs. For example, based on the configurations of LOs, the WTRU may receive configurations of N*K MOs (e.g., by receiving N*K sets of resources) for each LO where N may be a number of beams corresponding to LP-WUS and K may be a number of LP-WUS MOs for each beam. The configuration of LOs (e.g., each LO) and/or MOs (e.g., each MO) may be based on one or more of the following.

One or more of a sequence ID, a scrambling ID and cell ID; in an example, the WTRU may receive a configuration of one or more of sequence ID, a scrambling ID and cell ID. For example, the WTRU may receive a LP-WUS in the LP-WUS resource by using a sequence which is generated by using the ID and/or data which is scrambled by using the ID (e.g., in time and/or frequency domain).

Signal structure; in an example, the WTRU may receive a configuration of signal structure. For example, the WTRU may receive one of support of preamble, preamble length (if configured), message type (e.g., sequence and/or encoded data), number of repetition and etc.

Waveform; in an example, the WTRU may receive a configuration of waveform. For example, the WTRU may receive one of OOK-1, OOK-4, OFDMA or etc. as a waveform of LP-WUS. For OOK-4, M can be additionally configured.

Monitoring type; in an example, the WTRU may receive a configuration of monitoring type. For example, the WTRU may receive one of continuous monitoring and duty-cycled monitoring.

Frequency resources; in an example, the WTRU may receive a configuration of absolute frequency resources. For example, the WTRU may receive a configuration based on one or more of RBs, subbands, BWPs and etc. to indicate frequency resources for receiving LP-WUS. In another example, the WTRU may receive a configuration of relative time resources. For example, the WTRU may receive frequency offset (e.g., in RBs/subbands/RBGs) from one or more reference resources

In an example, the WTRU may receive a configuration of absolute time resources. For example, the WTRU may receive a configuration based on one or more of periodicity, offsets and etc. The indication of configuration may be based on OFDM symbols, slots, etc. In another example, the WTRU may receive an implicit configuration of time resources. For example, the WTRU may receive time offset (e.g., in symbols/subframes/frames) from one or more reference resources.

The one or more reference resources may be one or more of the start of the frame, an associated paging frame, an associated paging occasion, one or more associated LOs (e.g., for MOs), an associated PEI search space, SSB (PSS or SSS in NR-SS), LP-SS and etc.

Configurations for LP-WUS may include a number of subgroups (e.g., for LP-WUS operation or for each LP-WUS MO). In an example, the WTRU may receive information of number of subgroups for LP-WUS. In an example, the number of subgroups may be total number of subgroups for LP-WUS operation. In another example, the number of subgroups may be a number of subgroups supported by each LO or MO.

In another example, the WTRU may determine a number of subgroups based on the received information. For example, the WTRU may use the number of subgroups for PEI as the number of subgroups for LP-WUS. In another example, the WTRU may determine the number of subgroups for LP-WUS as a scaling factor * the number of subgroups for PEI. The scaling factor may be indicated via one or more of SIB, RRC and MAC CE.

Configurations for LP-WUS may include size of LP-WUS information. In an example, the WTRU may receive information of LP-WUS payload size. For example, up to 8, 16 or 24 bits may be indicated. The WTRU may receive size of LP-WUS information for each information type. For example, the WTRU may receive a first size of LP-WUS information for a first information type (e.g., for one or more of TRS availability indication, SI change, ETWS/CMAS information and etc.). The WTRU may receive a second size of LP-WUS information for a second information type (e.g., subgroup indication).

Configurations for LP-WUS may include LP-WUS frame offset. In an example, the WTRU may receive frame offset for LP-WUS. For example, the WTRU may receive offset from the start of a reference frame for LP-WUS (e.g., the start of a frame) to the start of a first paging frame of the paging frames associated with LP-WUS monitoring for the WTRU.

Configurations for LP-WUS may include LP-WUS symbol offset. In an example, the WTRU may receive symbol offset for LP-WUS. For example, the WTRU may receive offset (e.g., in number of symbols) from the start of the frame to the start of the first LP-WUS monitoring occasion (e.g., for monitoring LP-WUS).

Configuration information may include subgroup ID. In an example, the WTRU may receive subgroup ID (e.g., for PEI and/or LP-WUS). For example, the WTRU may receive subgroup ID(s) from AMF via NAS signaling (e.g., in CN based subgrouping). In another example, the WTRU may determine the subgroup ID based on the UE ID and the total number of subgroups for UE ID based subgrouping.

In an example, the WTRU may receive a subgroup ID for both PEI and LP-WUS). In another example, the WTRU may receive a first subgroup ID for PEI and a second subgroup ID for LP-WUS. In another example, the WTRU may receive a subgroup ID for PEI and determine a subgroup ID for LP-WUS based on the received information. In another example, the WTRU may determine subgroup IDs for PEI and LP-WUS, respectively, based on the received information (e.g., UE ID).

In an example, the WTRU may determine one or more associated POs with the WTRU. For example, the WTRU may determine one or more associated POs based on the UE ID. In an example, the WTRU may determine PO ID based on i_s: floor (UE_ID/N) mod N¬s. In another example, i_PO=((UE_IDmodN)·N_S+i_s ) mod N_PO\hat{ }PEI may be used.

In an embodiment, the WTRU may determine one or more LOs associated with the WTRU. The WTRU may determine the one or more LOs based on one or more of the following:

The WTRU may determine one or more LOs based on WTRU ID. For example, the WTRU may determine the one or more LOs based on the UE ID. For example, an associated LO ID may be floor (UE_ID/N) mod N_LO wherein N_LO may be total number of LOs (e.g., for a PF).

The WTRU may determine one or more LOs based on an associated PO. Based on the determined POs, the WTRU may determine one or more LOs. For example, a LO may be associated with each PO (e.g., based on time and/or frequency offset). The WTRU may determine a LO which is associated with the determined PO (e.g., based on the UE ID).

The WTRU may determine one or more LOs based on an associated PF. For example, the WTRU may determine one or more associated PFs based on the UE ID. Based on the determined PFs, the WTRU may determine one or more LOs. For example, a LO may be associated with each PF (e.g., based on time and/or frequency offset). The WTRU may determine a LO which is associated with the determined PF (e.g., based on the UE ID).

In an embodiment, the WTRU may determine one or more MOs associated the WTRU. The WTRU may determine the one or more MOs based a UE ID; for example, the WTRU may determine the one or more LOs based on the UE ID.

The WTRU may determine the one or more MOs based on an associated PO. Based on the determined PO, the WTRU may determine one or more MOs. For example, one or more MOs may be associated with each PO (e.g., based on time and/or frequency offset). The WTRU may determine one or more MOs which is associated with the determined PO (e.g., based on the UE ID).

The WTRU may determine the one or more MOs based an associated LO. Based on the determined LO, the WTRU may determine one or more MOs. For example, a LO may be associated with each PO (e.g., based on time and/or frequency offset). The WTRU may determine one or more MOs which is associated with the determined PO (e.g., based on the UE ID).

The WTRU may determine the one or more MOs based an associated PF. For example, the WTRU may determine one or more associated PFs based on the UE ID. Based on the determined PFs, the WTRU may determine one or more LOs. For example, a LO may be associated with each PF (e.g., based on time and/or frequency offset). The WTRU may determine a LO which is associated with the determined PF (e.g., based on the UE ID).

In an embodiment the WTRU may LP-WUS information based on the received information. For example, the WTRU may determine whether to split the subgroup information into two or more LOs and/or MOs. For example, the WTRU may determine whether to split the subgroup information based on the size of LP-WUS information. For example, the WTRU may determine the number of subgroups based on the size of LP-WUS information (e.g., for subgroups) and the number of subgroups for LP-WUS. For example, if the size of LP-WUS information (e.g., for all LP-WUS or all subgroup information)>=required size of information for all subgroups (e.g., the number of all subgroups (e.g., for LP-WUS) if bitmap is used), the WTRU may receive information of all subgroups within one associated LO or MO of the LP-WUS with the WTRU. If the size of LP-WUS information (e.g., for all LP-WUS or all subgroup information)<required size of information for all subgroups (e.g., the number of subgroups (e.g., for LP-WUS) if bitmap is used), the WTRU may receive information of all subgroups within two or more associated LOs or MOs.

Based on the determination, the WTRU may split the subgroup information into two or more LOs and/or MOs. The split of the subgroup information may be based on a number of subgroups for each LO or MO. For example, the WTRU may receive a number of subgroups for each LO or MO (e.g., via one or more of SIB, RRC and MAC CE). Based on the number of subgroups, the WTRU may determine LOs or MOs indicating a set of subgroups. For example, if 8 subgroup is supported and 4 subgroups for each MO is indicated, then first 4 subgroup information may be indicated in a first MO and second 4 subgroup information may be indicated in a second MO.

The split of the subgroup information may be based on a number of associated LOs/MOs. For example, the WTRU may determine a number of subgroups for each LO or MO based on the number of associated LOs (e.g., per PO or paging frame e.g., within a same beam) or POs (e.g., per LO, PO or paging frame e.g., within a same beam). The WTRU may receive S subgroups in each MO wherein S may be total number of subgroups/K (number of MOs within a LO with a same beam).

The split of the subgroup information may be based a number of subgroups for PEI. For example, the WTRU may receive a total number of subgroups for PEI (e.g., via one or more of SIB, RRC and MAC CE). For example, the WTRU may receive indication of the total number of subgroups for PEI in each LO or MO. For example, if 8 subgroups are configured for PEI and 16 subgroups are configured for LP-WUS, then a first MO may indicate a first 8 subgroup and a second MO may indicate a second 8 subgroup.

In a solution, the WTRU may determine a subgroup ID of the WTRU for LP-WUS. The determination may be based on an identical subgroup ID with PEI. In an example, the WTRU may use a same subgroup ID used for PEI. The same subgroup ID may be used if number of subgroups for LP-WUS is same with number of subgroups for PEI (e.g., if number of subgroup in LP-WUS=number of subgroup in PEI).

The split of the subgroup information may be based on a indicated subgroup ID for LP-WUS. In an example, the WTRU may receive an indication of a subgroup ID for LP-WUS (e.g., via one or more of NAS signaling from AMF, SIB, RRC and MAC CE).

The split of the subgroup information may be based on a determined subgroup ID for LP-WUS. In a solution, the WTRU may determine a subgroup ID for LP-WUS. For example, the WTRU may determine a UE subgroup ID for LP-WUS based on the UE subgroup ID for PEI. For example, e.g., if number of subgroup in LP-WUS>number of subgroup in PEI, UE subgroup ID in LP-WUS may be UE subgroup ID in PEI * Number of subgroup in LP-WUS/number of subgroup in PEI (or indicated scaling factor)+mod(UE_ID, Number of subgroup in LP-WUS/number of subgroup in PEI (or indicated scaling factor)). In another example, e.g., if number of subgroup in LP-WUS<number of subgroup in PEI, UE subgroup ID in LP-WUS may be floor (UE subgroup ID/Number of subgroup in LP-WUS*number of subgroup in PEI).

In an embodiment, the WTRU may determine LOs and MOs to monitor LP-WUS. The MOs and LOs to be monitored may be one or more of the following. For example, the WTRU may monitor all LOs/MOs associated with the WTRU (e.g., based on UE ID and the associated PO). For example, the WTRU may monitor LOs/MOs associated with the WTRU's subgroup ID (e.g., among the LOs/MOs associated with the UE ID and the associated PO). For example, the WTRU may only monitor LOs/MOs which indicates the determined WTRU's subgroup ID. For example, the WTRU monitors LOs/MOs delivering common information. For example, the WTRU may monitor LOs/MOs delivering TRS availability information, SI change, ETWS/CMAS information and etc.

In a solution, the WTRU may apply indicated information via LP-WUS if the WTRU detects LP-WUS in the determined LOs and MOs. For example, if the WTRU detects SI change, the WTRU may apply the indicated set of system information. In an example, if the WTRU detects SI change, the WTRU may activate MR and/or receive updated system information. In an example, if the WTRU receives ETWS/CMAS information, the WTRU may apply the indicated information. If the WTRU detects TRS availability indication, the WTRU may use the indicated information to identify TRS location for time/frequency synchronization when the WTRU monitors PDCCH (e.g., after activation of MR). In an example, if the WTRU detects LP-WUS indicating the WTRU's subgroup ID (e.g., for LP-WUS) in a received LP-WUS, the WTRU may monitor PEI and/or the associated PO with the WTRU. If the WTRU receives a paging message, the WTRU may respond e.g., sends a PRACH.

Hereafter, UL transmission mode may be exchangeable used with UL transmitter type consistent with the description. Hereafter, DL reception mode may be exchangeable used with DL receiver type, but still consistent with this invention. Hereafter, UL transmission mode and UL transmitter type may be exchangeable used with DL transmission mode and DL transmitter type, but still consistent with this invention.

In an embodiment, a WTRU may indicate WTRU capability on support of multiple UL transmitter. For example, WTRU capabilities on one or more of the following may be indicated (e.g., via one or more of RRC, MAC CE, UCI and UAI).

The WTRU may indicate one or more supported transmitter types. For example, the WTRU may indicate one or more of low complexity UL transmitter (e.g., UL transmitter based on back scattering with/without energy storage and/or signal amplification), high complexity UL transmitter (e.g., UL transmitter with energy storage and signal amplification) and MR based UL transmitter. Among the candidate UL transmitters, some UL transmitters (e.g., high complexity UL transmitter and/or MR based UL transmitter) may be supported as mandatory. In case of mandatory UL transmitters, the WTRU may not indicate associated capabilities.

The WTRU may indicate one or more supported receiver types. For example, the WTRU may indicate one or more of low complexity DL receiver (e.g., DL receiver based on OOK), high complexity DL receiver (e.g., DL receiver based on OFDM) and MR based DL receiver. Among the candidate DL receivers, some DL receivers (e.g., low complexity DL receiver and/or MR based DL receiver) may be supported as mandatory. In case of mandatory DL receivers, the WTRU may not indicate associated capabilities.

In an example embodiment, a WTRU may receive one or more of configurations for determining UL transmitters and/or DL receivers to be activated. For example, one or more of the following information (e.g., via one or more of RRC, MAC CE, SIB and DCI) can be configured.

The one or more of configurations may include DL/UL reciprocity/correspondence. For example, the WTRU may receive an indication on whether DL/UL reciprocity/correspondence (e.g., at gNB by sharing TXRU for DL and UL) is supported. If DL/UL reciprocity/correspondence is configured, the WTRU may support WTRU operation based on same channel characteristics between DL channel and UL channel.

The one or more of configurations may include thresholds for determining an UL transmission mode and/or a DL reception mode. For example, the WTRU may receive one or more thresholds for determining an UL transmission mode and/or a DL reception mode. The thresholds may be configured for one or more of each UL transmission mode, each DL reception mode, each receiver type, each transmitter type and etc. The thresholds may be configured based on channel quality (e.g., RSRP, RSRQ, SINR, CQI, hypothetical PDCCH BLER and etc.). For example, the one or more of the following configurations may be provided: one or more LR measurement thresholds for determining an UL transmission mode; one or more MR measurement thresholds for determining an UL transmission mode; one or more LR measurement thresholds for determining a DL reception mode; one or more MR measurement thresholds for determining a DL reception mode

The one or more of configurations may include thresholds for simplified CSI reporting. For example, the WTRU may receive one or more thresholds for simplified CSI reporting. The thresholds may be configured for one or more of each UL transmission mode, each DL reception mode, each receiver type, each transmitter type and etc. The thresholds may be configured based on channel quality (e.g., RSRP, RSRQ, SINR, CQI, hypothetical PDCCH BLER and etc.).

The one or more of configurations may include measurement related configurations for determining an UL transmission mode and/or a DL reception mode. For example, the WTRU may receive one or more RSs to measure channel qualities for determining an UL transmission mode and/or a DL reception mode. The one or more RSs may be commonly used for different usages and transmission/reception modes. The one or more RSs may be configured for one or more of each UL transmission mode, each DL reception mode, each receiver type, each transmitter type and etc. For example, the one or more of the following configurations may be provided: one or more RSs for MR (e.g., SSBs and/or CSI-RS resources for MR based UL transmission mode and/or OFDM based LR); and one or more RSs for LR (e.g., LP-SSs for low power transmitters and/or OOK based LR).

The one or more of configurations may include UL transmission related configurations. For example, the WTRU may receive a configuration of one or more UL resources. The one or more UL resources may be one or more of PUCCH resources, PUSCH resources, UL RS resources (e.g., SRS, DMRS, PTRS and etc.) and PRACH resources. The one or more UL resources may be commonly used for different usages. For example, different DL/UL transmission modes and different transmitters/receivers may share the one or more UL resources. The one or more UL resources may be separately configured for one or more of each purpose (e.g., one or more of indication of mode of operation/transmitter/receiver, UL RS transmission, acknowledgment of a gNB indication, CSI report and periodic status update), each UL transmission mode, each DL reception mode and each receiver type and each transmitter type. For example, a first set of UL resources may be configured for low complexity UL transmission mode (e.g., back scattering based transmission), a second set of UL resources may be configured for high complexity UL transmission mode (e.g., sequence based transmission) and a third set of UL resources may be configured for MR based UL transmission mode.

Type of UL resources may be different for one or more of each UL transmission mode, each DL reception mode and each receiver type and each transmitter type. For example, UL resources for low power transmission mode may be resources for back scattering transmission. UL resources low power transmission may be resources for sequence transmission. UL resources for MR based transmission may be resources for OFDM and/or DFT-s-OFDM transmission.

The one or more UL resources may be used for an indication of UL transmission mode/transmitter and/or DL reception mode/receiver to be activated. For example, the WTRU may indicate UL transmission mode/transmitter and/or DL reception mode/receiver based on the one or more UL resources.

The indication may be explicit. For example, the WTRU may indicate UL transmission mode/transmitter and/or DL reception mode/receiver to be activated based on the information (e.g., 0: low power transmission mode and 1: MR based transmission mode).

The indication may be implicit. For example, the WTRU may indicate UL transmission mode/transmitter and/or DL reception mode/receiver by transmitting associated sequence. In another example, the WTRU may indicate UL transmission mode/transmitter and/or DL reception mode/receiver by transmitting an UL signal in one or more associated UL resources.

The one or more UL resources may be used for UL RS transmission. For example, the WTRU may transmit one or more UL RSs (e.g., for determining UL transmission mode/transmitter and/or DL reception mode/receiver).

The one or more UL resources may be used for acknowledgement of a gNB indication. For example, the WTRU may confirm the indication of UL transmission mode/transmitter and/or DL reception mode/receiver based on the one or more UL resources (e.g., from a gNB). The indication may be explicit. For example, the WTRU may indicate ACK/NACK based on the information (e.g., 0: NACK and 1: ACK). The indication may be implicit. For example, the WTRU may indicate ACK/NACK by transmitting associated sequence. In another example, the WTRU may indicate ACK/NACK by transmitting an UL signal in one or more associated UL resources.

The one or more UL resources may be used for CSI report. For example, the may indicate of CSI based on the one or more UL resources. The CSI may be commonly used for different transmission modes/reception modes. For example, different DL/UL transmission modes and different transmitters/receivers may share the same type of CSI.

The CSI may be different for one or more of each UL transmission mode, each DL reception mode and each receiver type and each transmitter type. For example, a first type of CSI may be used for low complexity UL transmission mode (e.g., CQI difference based on thresholds), a second type of CSI may be used for high complexity UL transmission mode (e.g., CQI difference based on thresholds or normal CSI) and a third type of CSI (e.g., normal CSI by using one or more of CRI/SSBRI, RI, LI, PMI, CQI and etc.) may be used.

Indication methods of the CSI may be different for one or more of each UL transmission mode, each DL reception mode and each receiver type and each transmitter type. For example, a first type of CSI transmission mode (e.g., back scattering based) may be used for low complexity UL transmission mode. A second type of CSI transmission mode (e.g., sequence based) may be used for high complexity UL transmission mode. A third type of CSI transmission mode (e.g., OFDM based) may be used for MR based UL transmission mode.

The one or more UL resources may be used for status update. For example, the WTRU may indicate its status (e.g., periodically) based on the one or more UL resources. The indication may be commonly used for different transmission modes/reception modes. For example, different DL/UL transmission modes and different transmitters/receivers may support the indication.

The indication methods may be different for one or more of each UL transmission mode, each DL reception mode and each receiver type and each transmitter type. For example, a first type of the indication may be used for low complexity UL transmission mode (e.g., based on back scattering), a second type of the indication may be used for high complexity UL transmission mode (e.g., based on sequence transmission) and a third type of the indication (e.g., based on explicit indication) may be used.

Support of the indication may be different for one or more of each UL transmission mode, each DL reception mode and each receiver type and each transmitter type. For example, the indication may only be supported only for low complexity UL transmission mode (e.g., based on back scattering and/or sequence based transmission).

The one or more configurations received by the WTRU may include DL reception related configurations. For example, the WTRU may receive a configuration of one or more DL resources. The one or more DL resources may be one or more of CORESETs/SearchSpaces, PDSCH resources, and DL RS resources (e.g., SSB, CSI-RS, DMRS, PTRS and etc.).

The one or more DL resources may be commonly used for different usages. For example, different DL/UL transmission modes and different transmitters/receivers may share the one or more DL resources. The one or more DL resources may be separately configured for one or more of each purpose (e.g., indication of mode of operation/transmitter/receiver), each UL transmission mode, each DL reception mode and each receiver type and each transmitter type. For example, a first set of DL resources may be configured for low complexity UL transmission mode (e.g., back scattering based transmission), a second set of DL resources may be configured for high complexity UL transmission mode (e.g., sequence based transmission) and a third set of DL resources may be configured for MR based UL transmission mode.

Type of DL resources may be different for one or more of each UL transmission mode, each DL reception mode and each receiver type and each transmitter type. For example, DL resources for low power transmission mode may be resources for OOK based signal. DL resources low power transmission may be resources for OFDM based sequence transmission. DL resources for MR based transmission may be resources for OFDM transmission.

The one or more DL resources may be used for indication of UL transmission mode/transmitter and/or DL reception mode/receiver to be activated. For example, the WTRU may receive (e.g., from a gNB) UL transmission mode/transmitter and/or DL reception mode/receiver based on the one or more DL resources.

The indication may be explicit. For example, the WTRU may receive an indication of UL transmission mode/transmitter and/or DL reception mode/receiver to be activated based on the information (e.g., 0: low power transmission mode and 1: MR based transmission mode).

The indication may be implicit. For example, the WTRU may receive an indication of UL transmission mode/transmitter and/or DL reception mode/receiver by receiving associated sequence. In another example, the WTRU may receive an indication of UL transmission mode/transmitter and/or DL reception mode/receiver by receiving a DL signal in one or more associated DL resources.

DL reception related configurations may include DL RS reception . For example, the WTRU may receive one or more DL RSs (e.g., for determining UL transmission mode/transmitter and/or DL reception mode/receiver).

DL reception related configurations may include receiving a confirmation (e.g., from a gNB). For example, the WTRU may receive a confirmation of the indicated UL transmission mode/transmitter and/or DL reception mode/receiver based on the one or more UL resources (e.g., from a gNB).

The WTRU may receive the indication by receiving a signal in the configured DL resources. For example, if the WTRU detects a signal in the configured DL resources, the WTRU may identify the signal as ACK or NACK. The indication may be explicit. For example, the WTRU may receive ACK/NACK based on the information (e.g., 0: NACK and 1: ACK). The indication may be implicit. For example, the WTRU may receive ACK/NACK by receiving associated sequence. In another example, the WTRU may receive ACK/NACK by transmitting an UL signal in one or more associated UL resources.

The one or more configurations received by the WTRU may include configurations on fall back operation. For example, one or more time windows (e.g., for fall back operation). The one or more time windows may be commonly used for different usages. For example, different DL/UL transmission modes and different transmitters/receivers may share the one or more DL resources. The one or more time windows may be separately configured for one or more of each purpose (e.g., indication of mode of operation/transmitter/receiver), each UL transmission mode, each DL reception mode and each receiver type and each transmitter type. For example, a first time window may be configured for low complexity UL transmission mode (e.g., back scattering based transmission), a second time window may be configured for high complexity UL transmission mode (e.g., sequence based transmission) and a third time window may be configured for MR based UL transmission mode.

The configurations on fall back operation one or more counters (e.g., for fall back operation). The one or more counters may be commonly used for different usages. For example, different DL/UL transmission modes and different transmitters/receivers may share the one or more DL resources. The one or more counters may be separately configured for one or more of each purpose (e.g., indication of mode of operation/transmitter/receiver), each UL transmission mode, each DL reception mode and each receiver type and each transmitter type. For example, a first counter may be configured for low complexity UL transmission mode (e.g., back scattering based transmission), a second counter may be configured for high complexity UL transmission mode (e.g., sequence based transmission) and a third counter may be configured for MR based UL transmission mode.

The one or more configurations received by the WTRU may include configurations on energy harvesting operation. The configurations may include one or more remaining energy thresholds. For example, the WTRU may be configured with one or more thresholds for remaining energy. The remaining energy thresholds may be defined as remaining energy, percentage, watt, watt hour and etc.

Energy harvesting configuration may include one or more signal strength thresholds. For example, the WTRU may be configured with one or more thresholds for signal strength. The signal strength thresholds may be defined as RSRP, watt, watt hour and etc.

In an embodiment, a WTRU may determine a mode for determining an UL transmission mode (e.g., back scattering, sequence based or MR based) and/or DL reception mode (e.g., OOK based DL reception and/or OFDM based DL reception). The WTRU may determine the mode for determining an UL transmission mode and/or DL reception mode based on gNB configuration/indication. For example, the WTRU may receive a configuration/indication (e.g., from a gNB) to indicate which determination mode (e.g., between DL measurement based determination and UL transmission based determination (e.g., via gNB indication) is used. The indication may be based on one or more of SI, RRC, MAC CE and DCI.

The WTRU may determine the mode for determining an UL transmission mode and/or DL reception mode based on gNB capability. For example, the WTRU may determine the mode based on gNB capability. For example, if the gNB supports DL and UL channel reciprocity and/or correspondence, then the WTRU may determine the mode based on DL measurements based determination. If the gNB does not support DL and UL channel reciprocity and/or correspondence, then the WTRU may determine the mode based on UL transmission (e.g., via gNB indication on which UL transmission mode and/or DL reception mode). The gNB capability may be indicated based on one or more of SI, RRC, MAC CE and DCI.

The WTRU may determine the mode for determining an UL transmission mode and/or DL reception mode based on WTRU capability. For example, the WTRU may determine the mode based on WTRU capability. For example, if the WTRU supports DL and UL channel reciprocity and/or correspondence, then the WTRU may determine the mode based on DL measurements based determination. If the WTRU does not support DL and UL channel reciprocity and/or correspondence, then the WTRU may determine the mode based on UL transmission (e.g., via gNB indication on which UL transmission mode and/or DL reception mode).

A WTRU that determines existence of reciprocity and/or correspondence between UL and DL may determine an UL transmission mode based on DL measurements. To this end, the WTRU may use one or more of the following steps and/or procedures.

The WTRU may measure one or more RSs for measurement (e.g., associated with a default receiver (e.g., MR or LR) and/or the activated receiver). For example, in an embodiment, the WTRU may measure signal quality by using a default receiver.

The default receiver may be MR and/or LR (e.g., OOK based and/or OFDM based). If the default receiver is an LR receiver (e.g., based on OOK), the WTRU may measure signal quality (e.g., LP-RSRP, LP-RSRQ or LP-SINR) of one or more RSs associated with LR. For example, the WTRU may measure signal quality (e.g., LP-RSRP, LP-RSRQ or LP-SINR) of one or more preconfigured/indicated/detected (e.g., via one or more of RRC signaling, MAC-CE indication, DCI indication) LP-SSs.

If the default receiver is an MR receiver or an LR receiver (e.g., based on OFDM), the WTRU may measure signal quality (e.g., (L1-)RSRP, (L1-)RSRQ, or (L1-)SINR) of one or more RSs associated with MR (e.g., SSB and/or CSI-RS). For example, the WTRU may measure signal quality (e.g., (L1-)RSRP, (L1-)RSRQ, or (L1-)SINR) of one or more preconfigured/indicated/detected (e.g., via one or more of RRC signaling, MAC-CE indication, DCI indication) SSBs and/or CSI-RSs.

In a solution, the WTRU may measure signal quality by using an activated receiver. If the activated receiver is an LR receiver (e.g., based on OOK), the WTRU may measure signal quality (e.g., LP-RSRP, LP-RSRQ or LP-SINR) of one or more RSs associated with LR. For example, WTRU may measure signal quality (e.g., LP-RSRP, LP-RSRQ or LP-SINR) of one or more preconfigured/indicated/detected (e.g., via one or more of RRC signaling, MAC-CE indication, DCI indication) LP-SSs.

If the activated receive is an MR receiver or an LR receiver (e.g., based on OFDM), the WTRU may measure signal quality (e.g., (L1-)RSRP, (L1-)RSRQ, or (L1-)SINR) of one or more RSs associated with MR. For example, the WTRU may measure signal quality (e.g., (L1-)RSRP, (L1-)RSRQ, or (L1-)SINR) of one or more preconfigured (e.g., via one or more of RRC signaling, MAC-CE indication, DCI indication) SSBs and/or CSI-RSs.

The WTRU may determine an UL transmission mode based on the measured signal quality of one or more RSs and one or more preconfigured (e.g., via one or more of RRC signaling, MAC-CE indication, and DCI indication) thresholds (e.g., a first UL threshold, a second UL threshold (e.g., the first UL threshold>the second UL threshold)).

For example, if the measured DL signal quality≥a first UL threshold, the WTRU may determine to activate low complexity UL transmission mode (e.g., backscattering based UL transmission). In an example, if the activated receiver is a LR receiver and measured signal quality of one or more LP-SSs≥a first UL threshold, the WTRU may determine to activate low complexity UL transmission mode. In an example, if the activated receiver is a MR receiver and measured signal quality of one or more SSBs and/or CSI-RSs≥a first UL threshold, the WTRU may determine to activate low complexity UL transmission mode

In an example, if the measured DL signal quality≥a second UL threshold, the WTRU may determine to activate high complexity UL transmission mode (e.g., sequence based UL transmission mode). In an example, if the activated receiver is a LR receiver and measured signal quality of one or more LP-SSs≥a second UL threshold, the WTRU may determine to activate high complexity UL transmission mode. In an example, if the activated receiver is a MR receiver and measured signal quality of one or more SSBs and/or one or more CSI-RSs≥a second UL threshold, the WTRU may determine to activate high complexity UL transmission mode.

In an example, if the measured DL signal quality<the second UL threshold, the WTRU may determine to activate MR based UL transmission mode. In an example, if the activated receiver is a LR receiver and measured signal quality of one or more LP-SSs<the second UL threshold, the WTRU may determine to activate MR based UL transmission mode. In an example, if the activated receiver is a MR receiver and measured signal quality of one or more SSBs and/or one or more CSI-RSs<the second UL threshold, the WTRU may determine to activate MR based UL transmission mode.

The WTRU may activate the determined UL transmission mode. The activation of the determined UL transmission mode may include the WTRU may indicate the determined UL transmission mode to gNB. For example, if low complexity UL transmission mode is determined or used (e.g., for determination), the WTRU may indicate the selected UL transmission mode by reflecting all or a subset of RSs among one or more RSs transmitted by gNB. In an example, the WTRU may select a subset of RSs among one or more transmitted RSs by gNB based on signal quality (e.g., RS with the highest measured signal quality determined based on a prior reception occasion of one or more RSs) and reflect the selected subset of RSs. In another example, the WTRU may reflect a subset of RSs among one or more transmitted RSs associated with the determined UL transmission mode. To this end, WTRU may determine a subset of RSs to reflect based on a preconfigured (e.g., via one or more of RRC signaling, MAC-CE indication, DCI indication) association between UL transmission modes and one or more transmitted RSs.

If high complexity UL transmission mode is determined or used, the WTRU may indicate the selected UL transmission mode by transmitting one or more sequences to gNB. To this end, WTRU may select one or more UL sequences based on preconfigured (e.g., via one or more of RRC signaling, MAC-CE indication, DCI indication) association between UL transmission modes and a set of UL sequences.

The WTRU may activate an UL transmitter associated with the determined UL transmission mode. In an example, the WTRU may activate UL transmitter associated with the determined UL transmission mode until a new UL transmission mode is determined and/or configured or indicated by gNB.

In another example, the WTRU may activate UL transmitter associated with the determined (and indicated) UL transmission mode for a preconfigured (e.g., via one or more of RRC signaling, MAC-CE indication, DCI indication) duration (e.g., activation window) corresponding to the determined UL transmission mode. For example, WTRU may start a timer a preconfigured (e.g., via one or more of RRC signaling, MAC-CE indication, DCI indication) duration after transmitting indication of determined UL transmission mode to gNB). While the timer is running WTRU may activate and use the UL transmitter associated with the determined UL transmission mode. For example, if the determined UL transmission mode is low complexity UL transmission mode, the WTRU may activate backscattering based UL transmitter.

In another example, if the determined UL transmission mode is high complexity UL transmission mode, the WTRU may activate LR UL transmitter for sequence based transmission. In yet another example, if the determined UL transmission mode is MR based UL transmission mode, the WTRU may activate UL transmitter associated with MR.

In a solution, the WTRU may determine a mode for determination of UL transmission mode based on UL channel quality (e.g., measured at the gNB).

In an embodiment, the WTRU may transmit one or more RSs for determination of UL transmission mode. The transmission may be based on a default UL transmitter (e.g., low power UL transmission (e.g., based on back scattering and/or sequence based transmission) and/or MR based UL transmission).

For example, if the default UL transmission mode is a low complexity UL transmission mode (e.g., back scattering based), the WTRU may reflect one or more received DL RSs in the one or more UL resources (e.g., for low complexity UL transmitter).

For example, if the default UL transmission mode is a high complexity UL transmission mode (e.g., sequence based), the WTRU may transmit one or more sequences in the one or more UL resources (e.g., for high complexity UL transmitter).

For example, if the default UL transmission mode is a MR transmission mode, the WTRU may transmit one or more UL signals in the one or more UL resources (e.g., for MR based transmitter). The one or more UL signals may be one or more of SRS, DMRS, PTRS, PRACH and etc.

In an embodiment, the transmission may be based on a currently activated UL transmission mode/transmitter. For example, if the WTRU activated low complexity UL transmission, the WTRU may reflect one or more received DL RSs in the one or more UL resources for low complexity UL transmitter. For example, if the WTRU activated high complexity UL transmission, the WTRU may transmit one or more sequences in the one or more UL resources for high complexity UL transmitter. For example, if the WTRU activated MR, the WTRU transmits one or more UL resources (e.g., for MR based transmitter). The one or more UL signals may be one or more of SRS, DMRS, PTRS, PRACH and etc.

In an embodiment, the WTRU may receive an indication of UL transmission mode/transmitter (e.g., one or more of low complexity UL mode, high complexity UL mode and MR based UL mode) in one or more DL resources. The indication may be indicated in a common resource with an explicit indication. For example, the WTRU may receive an explicit indication indicating UL transmission mode/transmitter (e.g., 0: no activation, 1: activation of low complexity LP UL, 2: activation of high complexity LP UL, 3: activation of MR UL). The indication may be indicated by receiving DL resources and/or sequences associated with UL transmission mode. For example, the WTRU may receive a signal with a DL resource/sequence associated with UL transmission mode to be activated.

In an embodiment, the WTRU may support fall back operation based on reception of the indication of UL transmission mode/transmitter. For example, if the WTRU does not receive the indication in the one or more DL resources (e.g., within the time window and/or the counter), the WTRU may activates fall back UL transmitter. The fall back UL transmitter may be based on the currently activated UL transmission mode. For example, if the low complexity UL mode is activated, the WTRU may activate high complexity UL mode. In another example, if the high complexity UL mode is activated, the WTRU may activate MR based UL based UL mode.

In an embodiment, the WTRU may activate the indicated UL transmission mode/transmitter based on the indication. The activation of the indicated UL transmission mode/transmitter may be based on an activation window. For example, the WTRU may activate the newly indicated UL transmission mode/transmitter after an activation time window (e.g., from the indication or the confirmation (e.g., from a gNB)). The activation time window may be based on a type of an UL transmission mode to be activated. For example, a first activation time window may be used for low complexity UL transmission mode, a second activation time window may be used for high complexity UL transmission mode and a third activation time window may be used for MR based UL transmission mode.

In an embodiment, the WTRU may indicate/confirm activated UL transmission mode/transmitter. For example, the indication may be explicit (e.g., 0: low complexity UL, 1: high complexity UL and 2: MR based UL). In another example, the WTRU may transmit an UL signal in one or more UL resources (e.g., associated with the activated UL transmitter).

For example, if the WTRU activated low complexity UL transmission, the WTRU may reflect one or more received DL RSs in the one or more UL resources for low complexity UL transmitter. In another example, if the WTRU activated high complexity UL transmission, the WTRU may transmit one or more sequences in the one or more UL resources for high complexity UL transmitter. In another example, if the WTRU activated MR, the WTRU transmits one or more UL resources (e.g., for MR based transmitter). The one or more UL signals may be one or more of SRS, DMRS, PTRS, PRACH and etc.

In an embodiment, the WTRU may receive a confirmation (e.g., from the gNB). For example, the WTRU may receive a confirmation in one or more DL resources associated with the activated UL transmitter. In another embodiment, if the WTRU does not receive a confirmation (e.g., in the one or more DL resources), the WTRU may support a fall back operation. For example, if the WTRU does not receive a confirmation within the time window and/or the counter, the WTRU may activate fall back UL transmitter. The fall back UL transmitter may be based on the currently activated UL transmission mode. For example, if the low complexity UL mode is activated, the WTRU may activate high complexity UL mode. In another example, if the high complexity UL mode is activated, the WTRU may activate MR based UL based UL mode.

In an embodiment, the WTRU may support CSI operation based on a type of the activated UL transmitter. For example, the WTRU may activate the LP UL transmission modes (e.g., low complexity UL transmission mode and/or high complexity UL transmission mode) and may support CSI accordingly.

In an example, the WTRU may determine a type of CSI (e.g., simplified CSI reporting or regular CSI reporting). The WTRU may determine a type of CSI as described in the following examples.

An embodiment may include gNB configuration/indication. For example, the WTRU may receive a configuration/indication on the type of CSI. The configuration/indication may be via one or more of SI, RRC, MAC CE and DCI.

Determination may be based on a currently activated DL reception mode/receiver. For example, the WTRU may determine a type of CSI based on the currently activated DL reception mode/receiver. For example, if the WTRU activated MR based receiver and/or LP receiver (e.g., OFDM based), then the WTRU may determine a first type of CSI (e.g., regular CSI). For example, if the WTRU activated LP receiver (e.g., OOK based), then the WTRU may determine a second type of CSI (e.g., simplified CSI).

Determination may be based on a currently activated UL transmission mode/transmitter. For example, the WTRU may determine a type of CSI based on the currently activated UL transmission mode/transmitter. For example, if the WTRU activated MR based transmission mode and/or high complexity UL transmission mode (e.g., sequence based), then the WTRU may determine the first type of CSI (e.g., regular CSI). For example, if the WTRU activated low complexity UL transmission mode (e.g., back scattering based) and/or high complexity UL transmission mode (e.g., sequence based), then the WTRU may determine the second type of CSI (e.g., simplified CSI).

In an embodiment, the WTRU may measure one or more DL RSs for CSI reporting. The WTRU may determine a type of DL RS for CSI measurement as described in one or more of the following examples.

An example uses gNB configuration/indication. For example, the WTRU may receive a configuration/indication on the type of DL RS for CSI measurement. The configuration/indication may be via one or more of SI, RRC, MAC CE and DCI.

An example is based on CSI type. For example, the WTRU may determine a type of DL RS based on CSI type. For example, if the WTRU reports regular CSI reporting, the WTRU may determine MR RS based CSI measurements. If the WTRU reports simplified CSI reporting, the WTRU may determine LR RS based CSI measurements.

Determination may be based on a currently activated DL reception mode/receiver. For example, the WTRU may determine a type of DL RS for CSI measurement based on the currently activated DL reception mode/receiver. For example, if the WTRU activated MR based receiver and/or LP receiver (e.g., OFDM based), then the WTRU may determine MR RS (e.g., SSB and/or CSI-RS) based CSI measurements. For example, if the WTRU activated LP receiver (e.g., OOK based), then the WTRU may determine LP RS (e.g., LP-SS based on OOK) based CSI measurements.

Determination may be based on a currently activated UL transmission mode/transmitter. For example, the WTRU may determine a type of DL RS for CSI measurement based on the currently activated UL transmission mode/transmitter. For example, if the WTRU activated MR based transmission mode and/or high complexity UL transmission mode (e.g., sequence based), then the WTRU may determine MR RS (e.g., SSB and/or CSI-RS) based CSI measurements. For example, if the WTRU activated low complexity UL transmission mode (e.g., back scattering based) and/or high complexity UL transmission mode (e.g., sequence based), then the WTRU may determine LP RS (e.g., LP-SS based on OOK) based CSI measurements.

In a solution, the WTRU may support simplified CSI reporting (e.g., based on the determination of simplified CSI reporting mode). For example, the WTRU may report CSI based on one or more of the following: no information change (e.g., from a reference CSI); information change less than a first CSI threshold (e.g., from a reference CSI); information change less than a second CSI threshold (e.g., from a reference CSI); or information change more than the second CSI threshold (e.g., from a reference CSI)

In a solution, the WTRU may determine the reference CSI (e.g., for simplified CSI reporting). For example, the reference CSI may be based on one or more of the following. Indicated/configured CSI; for example, the WTRU may receive an indication and/or a configuration (e.g., from a gNB) on the reference CSI. For example, one or more CSI parameters (e.g., one or more of CRI/SSBRI, RI, LI, CRI, PMI, and CQI) may be configured/indicated. The configuration/indication may be via one or more of SI, RRC, MAC CE and DCI. Most recently reported regular CSI; for example, the WTRU may use most recently reported regular CSI as the reference CSI. Most recently reported CSI; for example, the WTRU may use most recently reported CSI (e.g., regardless of CSI type) as the reference CSI.

In an embodiment, the WTRU may support the CSI reporting with different indication methods. A CSI reporting indication may include gNB configuration/indication. For example, the WTRU may receive a configuration/indication the indication method. The indication method may be common for different UL transmission modes/transmitter and/or DL reception modes/receiver. The indication method may be indicated for each UL transmission mode/transmitter and/or DL reception mode/receiver separately. For example, a first indication method may be indicated for a first UL transmission mode and a second indication method may be indication for a second UL transmission mode.

A CSI reporting indication may be based on CSI type. For example, the WTRU may determine an indication method based on CSI type. For example, if the WTRU reports regular CSI reporting, the WTRU may determine a first indication type (e.g., indication via PUCCH/PUSCH). If the WTRU reports simplified CSI reporting, the WTRU may determine a second indication type (e.g., indication via back scattering and/or sequence transmission).

A CSI reporting indication may be a determination based on a currently activated DL reception mode/receiver. For example, the WTRU may determine an indication method based on the currently activated DL reception mode/receiver. For example, if the WTRU activated MR based receiver, then the WTRU may determine a first indication type (e.g., indication via PUCCH/PUSCH). For example, if the WTRU activated LP receiver (e.g., OFDM based), then the WTRU may determine a second indication type (e.g., sequence based). For example, if the WTRU activated LP receiver (e.g., OOK based), then the WTRU may a third indication type (e.g., back scattering based).

A CSI reporting indication may be determination based on a currently activated UL transmission mode/transmitter. For example, the WTRU may determine an indication method based on the currently activated UL transmission mode/transmitter. For example, if the WTRU activated MR based transmission mode, then the WTRU may determine a first indication method (e.g., indication via PUCCH/PUSCH). For example, if the WTRU activated high complexity UL transmission mode (e.g., sequence based), then the WTRU may determine a second indication type (e.g., sequence based). For example, if the WTRU activated low complexity UL transmission mode (e.g., back scattering based), then the WTRU may determine a third indication type (e.g., back scattering based).

In an embodiment, the WTRU may determine whether to support WTRU status update or not. The determination may be based on gNB configuration/indication. For example, the WTRU may receive a configuration/indication on whether to support WTRU status update. The indication may be common for different UL transmission modes/transmitter and/or DL reception modes/receiver. The indication may be indicated for each UL transmission mode/transmitter and/or DL reception mode/receiver separately. For example, a first configuration/indication may be used for a first UL transmission mode and a second configuration/indication method may be used for a second UL transmission mode.

The determination may be based on CSI type. For example, the WTRU may determine whether to support WTRU status update based on CSI type. For example, if the WTRU reports regular CSI reporting, the WTRU may determine a first mode (e.g., not supporting WTRU status update). If the WTRU reports simplified CSI reporting, the WTRU may determine a second mode (e.g., supporting WTRU status update).

The determination may be based on a currently activated DL reception mode/receiver. For example, the WTRU may determine whether to support WTRU status update based on the currently activated DL reception mode/receiver. For example, if the WTRU activated MR based receiver and/or LP receiver (e.g., OFDM based), then the WTRU may determine a first mode (e.g., not supporting WTRU status update). For example, if the WTRU activated LP receiver (e.g., OFDM based and/or OOK based), then the WTRU may determine a second mode (e.g., supporting WTRU status update).

The determination may be based on a currently activated UL transmission mode/transmitter. For example, the WTRU may determine whether to support WTRU status update based on the currently activated UL transmission mode/transmitter. For example, if the WTRU activated MR based transmission mode and/or high complexity UL transmission mode (e.g., sequence based), then the WTRU may determine a first mode (e.g., not supporting WTRU status update). For example, if the WTRU activated low complexity UL transmission mode (e.g., back scattering based) and/or high complexity UL transmission mode (e.g., sequence based), then the WTRU may determine a second mode (e.g., supporting WTRU status update).

In an embodiment, a WTRU may indicate WTRU status (e.g., to a gNB). The WTRU may indicate an activated UL transmission mode/transmitter. For example, the WTRU may indicate activated UL transmission mode/transmitter by explicitly indicating the information (e.g., 0: low complexity UL, 1: high complexity UL). In another example, the WTRU may indicate activated UL transmission mode/transmitter by transmitting an UL signal in associated one or more UL resources.

The WTRU may indicate an activated DL reception mode/receiver. For example, the WTRU may indicate activated DL reception mode/receiver by explicitly indicating the information (e.g., 0: OOK based LR, 1: OFDM based LR). In another example, the WTRU may indicate activated DL reception mode/receiver by transmitting an UL signal in associated one or more UL resources.

The WTRU may indicate an whether the WTRU is in coverage or not. For example, the WTRU may indicate whether the WTRU is in coverage or not by explicitly indicating the information (e.g., 0: out of coverage, 1: in coverage). In another example, the WTRU may indicate whether the WTRU is in coverage or not by transmitting an UL signal in associated one or more UL resources.

In an embodiment, the WTRU may determine an indication method for status update. The WTRU may determine gNB configuration/indication. For example, the WTRU may receive a configuration/indication the indication method. The indication method may be common for different UL transmission modes/transmitter and/or DL reception modes/receiver. The indication method may be indicated for each UL transmission mode/transmitter and/or DL reception mode/receiver separately. For example, a first indication method may be indicated for a first UL transmission mode and a second indication method may be indication for a second UL transmission mode.

The WTRU may indicate whether the WTRU is in coverage or not based on CSI type. For example, the WTRU may determine an indication method based on CSI type. For example, if the WTRU reports regular CSI reporting, the WTRU may determine a first indication type (e.g., indication via PUCCH/PUSCH). If the WTRU reports simplified CSI reporting, the WTRU may determine a second indication type (e.g., indication via back scattering and/or sequence transmission).

The WTRU may indicate whether the WTRU is in coverage or not by determination based on a currently activated DL reception mode/receiver. For example, the WTRU may determine an indication method based on the currently activated DL reception mode/receiver. For example, if the WTRU activated MR based receiver, then the WTRU may determine a first indication type (e.g., indication via PUCCH/PUSCH). For example, if the WTRU activated LP receiver (e.g., OFDM based), then the WTRU may determine a second indication type (e.g., sequence based). For example, if the WTRU activated LP receiver (e.g., OOK based), then the WTRU may a third indication type (e.g., back scattering based).

The WTRU may indicate whether the WTRU is in coverage or not by determination based on a currently activated UL transmission mode/transmitter. For example, the WTRU may determine an indication method based on the currently activated UL transmission mode/transmitter. For example, if the WTRU activated MR based transmission mode, then the WTRU may determine a first indication method (e.g., indication via PUCCH/PUSCH). For example, if the WTRU activated high complexity UL transmission mode (e.g., sequence based), then the WTRU may determine a second indication type (e.g., sequence based). For example, if the WTRU activated low complexity UL transmission mode (e.g., back scattering based), then the WTRU may determine a third indication type (e.g., back scattering based).

In an embodiment, the WTRU may support WTRU status update based on the determined indication mode. With back scattering, for example, the WTRU may transmit WTRU information (e.g., one or more of UE ID, UE group ID, cell ID, ACK/NACK) based on OOK/BPSK signal by reflecting DL signal. In another example, the WTRU may transmit a best beam by reflecting best DL beam RS (e.g., SSB and/or CSI-RS).

With sequence based, for example, the WTRU may transmit a sequence where in the sequence ID and/or UL resource are associated with the WTRU status information. With PUCCH/PUSCH based, for example, the WTRU may transmit WTRU information (e.g., one or more of UE ID, UE group ID, cell ID, ACK/NACK) via PUCCH/PUSCH. In another example, the WTRU may transmit a best beam by transmitting PUCCH/PUSCH (e.g., CSI and/or ACK/NACK in associated PUCCH/PUSCH resources).

In an embodiment, a WTRU may determine whether to support energy harvesting mode. Based on the determination, the WTRU may indicate energy harvesting related information. With gNB configuration/indication, for example, the WTRU may receive a configuration/indication (e.g., from a gNB) on whether to support energy harvesting. The indication may be based on one or more of SI, RRC, MAC CE and DCI.

With gNB capability, for example, the WTRU may determine the mode based on gNB capability. For example, if the gNB supports WTRU energy harvesting, then the WTRU may determine to support energy harvesting. If the gNB does not support WTRU energy harvesting, then the WTRU may determine not to support energy harvesting. The gNB capability may be indicated based on one or more of SI, RRC, MAC CE and DCI.

With WTRU capability, for example, the WTRU may determine the mode based on WTRU capability. For example, if the WTRU is capable of energy harvesting, then the WTRU may support energy harvesting. If the WTRU is not capable of energy harvesting, then the WTRU may not support energy harvesting.

In an embodiment, the WTRU may determine whether to trigger/start energy harvesting procedure.

Utilization of remaining energy thresholds may be used to determine whether to trigger/start energy harvesting procedure. In an embodiment, the WTRU may determine whether to trigger energy harvesting procedure based on remaining energy thresholds. For example, if remaining energy of the WTRU is less than a remaining energy threshold, the WTRU may trigger the energy harvesting procedure.

The WTRU may determine a duration for energy harvesting procedure based on remaining thresholds. For example, if remaining energy of the WTRU is less than a first remaining energy threshold, the WTRU may determine a first time duration. If the remaining energy is more than the first remaining energy threshold and less than a second remaining energy threshold, than the WTRU may determine a second time duration. If the remaining energy is more than the second remaining energy threshold, the WTRU may not trigger energy harvesting procedure.

Utilization of signal strength thresholds may be used to determine whether to trigger/start energy harvesting procedure. In an embodiment, the WTRU may determine whether to trigger energy harvesting procedure based on signal strength thresholds. For example, if measured energy of energy harvesting signal is larger than (or equal to) a signal strength threshold, the WTRU may trigger the energy harvesting procedure.

The WTRU may determine a duration for energy harvesting procedure based on signal strength thresholds. For example, if measured energy of energy harvesting signal is larger than a first signal strength threshold, the WTRU may determine a first time duration. If the measured energy is less than the first remaining energy threshold and more than a second signal strength threshold, than the WTRU may determine a second time duration. If the signal strength is less than the second signal strength threshold, the WTRU may not trigger energy harvesting procedure.

Currently activated DL reception mode/receiver may be used to determine whether to trigger/start energy harvesting procedure. For example, the WTRU may determine whether to trigger energy harvesting based on the currently activated DL reception mode/receiver. For example, if the WTRU activated MR based receiver and/or LP receiver (e.g., OFDM based), then the WTRU may determine a first mode (e.g., not triggering energy harvesting). For example, if the WTRU activated LP receiver (e.g., OFDM based and/or OOK based), then the WTRU may determine a second mode (e.g., trigger energy harvesting).

Currently activated UL transmission mode/transmitter may be used to determine whether to trigger/start energy harvesting procedure. For example, the WTRU may determine whether to support harvesting. For example, if the WTRU activated MR based transmission mode and/or high complexity UL transmission mode (e.g., sequence based), then the WTRU may determine a first mode (e.g., not triggering energy harvesting). For example, if the WTRU activated low complexity UL transmission mode (e.g., back scattering based) and/or high complexity UL transmission mode (e.g., sequence based), then the WTRU may determine a second mode (e.g., triggering energy harvesting).

In an embodiment, the WTRU may indicate energy harvesting related information (e.g., if the WTRU determine to trigger/start energy harvesting). For example, the WTRU may indicate whether the WTRU supports energy harvesting. Based on the WTRU indication, the WTRU may not receive/decode wake up signal (e.g., from a gNB) during a configured/predefined time duration. For example, the WTRU may indicate a duration which is required for energy harvesting. Based on the WTRU indication, the WTRU may not receive/decode wake up signal (e.g., from a gNB) during the indicated time duration.

A WTRU may be configured with MR and LR (Low power receiver and transmitter). The WTRU may be configured with a threshold for entry condition for Low power Wake-UP signal (LP-WUS) monitoring and a threshold for triggering or activating the initial access procedure (e.g., Rando Access (RA)) procedure via LR.

For example, an LR may indicate and/or second radio (e.g., not main radio) and/or OOK-based LR and/or OFDM-based LR and/or Low power transmitter and/or one of transmitter using in IoT system (e.g., sensor, metering, limited capability WTRU, IoT devices). For example, LR transmission activated with backscattering based on the reception of carrier wave with low complexity UL transmission. For example, the WTRU may transmit with LR using increased power (e.g., if amplifier is supported). For example, a WTRU may perform UL transmission with LR when the WTRU deactivated the main radio. For example, a WTRU may perform UL transmission with LR and receive/monitor LP-WUS with LR while the WTRU deactivated the main radio.

In one example, a base station may transmit a message. The message may comprise configuration with including one or more thresholds for activating LR and/or deactivating MR. The message may be delivered via SIB and/or via an RRC dedicated message and/or paging message and/or NAS signaling from core network. For example, the first threshold may be associated with LP-WUS monitoring entry and/or exit condition (e.g., whether monitoring LP WUS with LR or not). For example, the second threshold may be associated with LR transmission (e.g., whether to perform LR transmission based on backscattering or not). For example, the third threshold may be associated with LR with RA procedure (e.g., whether to perform 2-step or 4-step RA procedure).

In one example, a WTRU may determine to perform initial access procedure via LR, if at least one of the configured conditions from network is satisfied. For example, each of the threshold value (e.g., first threshold and/or second threshold and/or third threshold) may be configured with the same value or different values respectively.

In one example, if a first threshold of LP-WUS monitoring is satisfied (e.g., serving cell quality of measured RSRP/RSRQ value is above the first threshold), a WTRU may perform initial access procedure via LR (e.g., using active transmitter) and the WTRU may turn-off the main radio. If a first threshold of LP-WUS monitoring is not satisfied (e.g., serving cell quality of measured RSRP/RSRQ value is below the first threshold), a WTRU may perform initial access procedure via MR (e.g., LP-WUS exit condition is satisfied).

For example, if a second threshold of LP for transmission is satisfied (e.g., carrier wave quality of measured LP-RSRP/RSRQ value is above the second threshold), a WTRU may perform initial access procedure via LR (e.g., backscattering based on the reception of CW). If a second threshold of LP for transmission is not satisfied (e.g., carrier wave quality of measured LP-RSRP/RSRQ value is below the second threshold), a WTRU may perform initial access procedure via LR (e.g., using active transmitter, if supported or available). The WTRU may measure LP-RSRP/RSRQ value from the carrier wave via LR. The WTRU may receive a configuration for measuring time duration/periodicity (e.g., slots/msec) with LR from a network and/or the WTRU is (pre-)configured to measure time duration/periodicity (e.g., slots/msec) with LR.

For example, if a third threshold of LR for transmission is satisfied (e.g., serving cell quality of measured LP-RSRP/RSRQ value is above the third threshold), a WTRU may perform 2-step initial access procedure via LR. If a third threshold of LP for transmission is not satisfied (e.g., serving cell quality of measured LP-RSRP/RSRQ value is below the third threshold), a WTRU may perform 4-step initial access procedure via LR.

Upon transmitting the first message via LR (e.g., based on backscattering), the WTRU may not receive second message or another message (e.g., random access response) during the RACH procedure. For example, the WTRU may move during the RACH procedure and the WTRU may be located out of LR coverage (e.g., LP-WUS reception and transmission via LR). For example, LR transmission with backscattering is not delivered to the network due to the limited transmission coverage.

Upon detecting the failure of reception via LR (e.g., second message), the WTRU may perform retransmission via LR (e.g., first message) with power ramping. In one example, the WTRU may determine whether to perform retransmission with LR or MR based on the received quality of LR reception (e.g., LP-WUS signal or reception via LR). For example, if the quality of LR is below than a certain of level, the WTRU may activate the MR/deactivate LR and may perform retransmission (e.g., first message) via MR. For example, if the quality of LR is above than a certain of level, the WTRU activate LR transmission/deactivate MR (e.g., active transmission with power boosting, if supported) and may perform retransmission (e.g., first message) via LR.

In one example, the WTRU may determine whether to perform retransmission with LR or MR based on the number of transmission failure. For example, if the number of transmission failure is below than a certain number, the WTRU may activate LR transmission/deactivate MR (e.g., active transmission with power boosting, if supported) and may perform retransmission (e.g., first message) via LR. For example, if the number of transmission failure is reached to a certain number, the WTRU may activate the MR/deactivate LR and may perform retransmission (e.g., first message) via MR.

In one example, a WTRU may perform re-access procedure via activated LR. For example, when the conditions for LR is satisfied, the WTRU may transmit the first message (e.g., preamble, random number, device ID) for initial access procedure to a network. When a WTRU may receive an indication for performing re-access procedure (e.g., restart initial access procedure) during the initial access procedure, the WTRU may wait to receive subsequent paging message to perform re-access procedure.

For example, upon receiving an indication for re-access procedure, a WTRU may activate the LR/deactivate the main radio and may start to monitor LP-WUS signal based on the configuration of LP-WUS monitoring. For example, the configuration of LP-WUS monitoring signal may be associated monitoring time (e.g., periodicity and/or time duration and/or time window) via LR.

In one example, the WTRU may perform re-access upon receiving subsequent paging message with an indication for re-access. For example, the WTRU may perform re-access upon receiving an re-access indication for the WTRU (or subgroup ID of the WTRU) via activated LR.

For example, an indication for re-access may comprise further information with performing re-access. The indication for re-access may comprise/include to perform re-access condition via activated MR or activated LR. For example, if measured DL-RSRP is above than a certain level, the WTRU may perform re-access with LR. For example, if measure DL-RSRP value is below than a certain level, the WTRU may preform re-access with activated MR.

For example, an indication for re-access may include timing information to perform re-access in the next paging round and/or re-access with skipping one or more paging round and/or may indicate to re-access after energy harvesting.

When a WTRU is equipped with multiple transmitters, some of the transmitters may have lower coverage than others. For instance, a low-power or low-complexity UL transmitter such as back-scattering radio has (much) lower transmission power than regular MR and hence the coverage is limited.

However, other WTRUs in its vicinity may be able to monitor/overhear the low-power UL transmissions, and relay/forward it to the network, e.g., using a more powerful radio. This effectively creates a low-power UL relaying, extending the coverage of the UL low-power transmissions, and enabling the WTRU to remain or use low-power radios and preserve its battery.

This scenario is applicable-but not limited to-sets of WTRUs that may belong to the same user or operated by the same user/company, such as XR devices sets (e.g., a smartphone with a XR glasses), wearables associated to a main device at home, Industrial IoT, etc. The WTRUs are cooperating to enhance the battery life/coverage of the weakest devices, as cooperative communications, and may be viewed as relaying or aggregative communications.

Note that the following solutions are applicable in complement, replacement or combination with the solutions presented in previous sections without limitations. Common aspects with previous solutions may be omitted in the following but still applicable.

In one solution, the WTRU may receive multiple sets of (pre-)configurations for determining the UL transmission mode, e.g., to determine whether to use a low-complexity, low-power UL transmitter, a low-power, high-complexity UL transmitter or a MR. Each set of configurations may be similar as the one described in previous section, e.g., including measurement related configuration, thresholds for UL transmitter selection, UL resource configuration, etc. Each set of configurations may be associated with a relaying/cooperating condition with other WTRUs.

In one example, a first set of configurations may be associated with the presence of another WTRU/device relaying LP-UL transmissions, while a second set of configurations may be associated with the absence of another WTRU/device relaying LP-UL transmissions.

In one example, the WTRU may be configured with multiple sets of configuration, each corresponding to different LP-relays. E.g., the thresholds for selections may be configured by the network depending on the proximity with the relay.

In one example, the WTRU may receive the indication of the WTRU relaying the LP signals, or whether or not the set of configurations corresponds to a relayed configuration or non-relayed configuration.

In one example, the sets of configurations are indexed. For example, if the WTRU receives two sets of configurations, a binary index may be used to refer to the first or the second set.

In one example, a first set of configuration, associated with a LP-relayed configuration, may include measurement thresholds for determining the UL transmission mode that are lower than the thresholds in a second (non-relayed) configuration. For instance, when the WTRU has its LP transmissions relayed, its coverage is extended and is not necessary to reach the network directly.

In one example, a first set of configuration, associated with a LP-relayed configuration, may include measurement resources that are different that the measurement resources for a second (non-relayed) configuration.

In one example, measurement resources from the first and second set of configuration both indicate resources for transmissions from the network, e.g., in DL resources, e.g., LP-SS, SSBs, DL RSs or LP-RS, but may be different, e.g., using different DL beams or RS. In another example, the measurement resources from the first configuration indicate resources/RS transmitted by the relay WTRU, e.g., in UL or WTRU-to-WTRU transmission resources, while the second configuration measurement resources are using DL resources. This would enable the WTRU to measure the coverage from to its relay and help determine whether the UL transmission mode is suitable (e.g., if the measurement>threshold). The source of the transmission in the measurement resource may be transparent to the WTRU, i.e., the WTRU may not be aware of whether it is measuring a RS from the network or from another WTRU, except for the format and configuration of the RS itself if they are different (e.g., for MR based).

In an example, a first set of configuration, associated with a LP-relayed configuration, may include UL transmission configuration (e.g. resources, transmit power) that are different that the measurement resources for a second (non-relayed) configuration. For instance, the transmit power, if controllable by the WTRU, may be lower for the relayed configuration compared to the non-relayed configuration. For instance, the transmission resource, if controllable, may be indicated in UL resources or in WTRU-to-WTRU resources when relayed.

In an embodiment, the WTRU may receive a configuration from the network indicating whether the WTRU is being relayed by another WTRU or not. Alternatively/similarly, the WTRU may receive from the network an indication of which set of configuration to use for the UL transmission mode determination.

In an example, the WTRU may receive a configuration indicating that its LP transmissions are relayed by another WTRU, hence the WTRU is indicated to use the set of configuration corresponding to the LP-relayed configuration. In another example, the WTRU may receive a configuration indicating that its LP transmissions are not relayed by another WTRU, hence the WTRU is indicated to use the set of configuration corresponding to the non-LP-relayed configuration.

In another example, the WTRU may receive a configuration indicating that a first LP transmission mode, e.g., the low-power, low-complexity (back-scattering) is relayed by another WTRU, but a second LP transmission mode (e.g., sequence-based) is not relayed, hence the WTRU is indicated to use the set of configuration corresponding to the LP-relayed configuration for the thresholds corresponding to the first UL transmission mode, but the set of non-relayed configuration for the thresholds corresponding to the second UL transmission mode.

In another example, the WTRU may receive the configuration as a binary/indexed value, corresponding to the received (indexed) set of configuration. For instance, a 0 may be mapped to a non-relayed configuration while a 1 mapped to a relayed configuration.

In another example, in the case where the WTRU receives the associated relay WTRU, the WTRU may be indicated with the WTRU (e.g., using UE ID) that is the relay, and the WTRU may select the set of configurations corresponding to that relay WTRU.

In another example, the WTRU may receive the configuration using its LP receiver. The may receive an indication as part of LP signaling, updating the configuration for the LP monitoring and (LP) UL transmission configuration. For examples, the WTRU may be configured to receive a dedicated LP control channel indicating configuration updates; or an indication may be carried using the LP-SS or LP-WUS indicating a configuration update.

In another example, the WTRU may receive the configuration using its MR receiver, e.g., using RRC (re)configuration. In another example, the WTRU may receive the configuration as an initial configuration, e.g., before/upon activating the LR/sleep mode. In another example, the WTRU may receive the (re)configuration as an update of the existing relaying configuration, to replace the previous relaying configuration

In one aspect, the WTRU may be (pre)configured with a default configuration, e.g., the WTRU may be by default configured to use the non-relayed configurations. For example, if the WTRU does not receive an indication of relayed transmissions or if the configuration does not include relayed indications, the WTRU uses the default configuration.

In an example embodiment, the WTRU may determine the UL transmission mode based on whether it is relayed by another WTRU or not, and based on other aspects as described in previous section, such as DL measurements or UL transmission with reception of indications.

In an example, the WTRU is configured or determined to determine the UL transmission mode based on measurements. The WTRU may first perform the measurements on the configured and activated radio, e.g., if the WTRU activated LR, the WTRU measures the one or more RSs for LR.

In an embodiment, the WTRU may determine the resources to perform measurements for UL transmission mode determination based on whether the WTRU is configured to be relayed or not. For example, the WTRU may receive a first set of configuration for relayed determination and a second set of configuration for non-relayed determination. Both sets of configuration may include RSs for measurements, for either/both LR and MR measurements. The WTRU may select and perform measurements on the configured RS corresponding to the set of configuration of the indicated relayed/non-relayed configuration.

In some examples, the WTRU received an indication of a relayed transmission, and may perform measurement on the (LR or MR, depending on the activated radio) RSs configured in the first set of configuration, e.g., based on configured resources, format and measurement. In one example, the WTRU uses LR to measure LP-RS transmitted by the relay WTRU. In another example, the WTRU uses LR to measure LP-RS transmitted by the network. In another example, the WTRU uses MR to measure RSs transmitted by the relay WTRU. In another example, the WTRU uses MR to measure RSs transmitted by the network.

In some examples, the WTRU received an indication of a non-relayed transmission, and may perform measurement on the (LR or MR, depending on the activated radio) RSs configured in the second set of configuration, e.g., based on configured resources, format and measurement. In one example, the WTRU uses LR to measure LP-RS transmitted by the network. In another example, the WTRU uses MR to measure RSs transmitted by the network.

In an embodiment, the WTRU may determine the UL transmission mode comparing the performed measurements to configured thresholds. The WTRU may determine the threshold to use based on whether or not the WTRU is indicated to be relayed. For example, the WTRU may receive a first set of configuration for relayed determination and a second set of configuration for non-relayed determination. The first set of configurations may include a first and second thresholds for selecting different transmission modes. The second set of configuration may include similar thresholds, with same or different values.

In some examples, the WTRU received an indication of a relayed transmission, and may evaluate the measurement on the (LR or MR, depending on the activated radio) RSs using the thresholds in the first set of configurations. In some examples, the WTRU received an indication of a non-relayed transmission, and may evaluate the measurement on the (LR or MR, depending on the activated radio) RSs using the thresholds in the second set of configurations.

In an example, the WTRU determines to use the first transmission mode (e.g., back-scattering) based on the measurement being higher than the first threshold. In another example, the WTRU determines to use the second transmission mode (e.g., sequence-based) based on the measurement being higher than the second threshold. In another example, the WTRU determines to use the transmission mode (e.g., MR) based on the measurement being lower than the second threshold.

In example embodiment, the WTRU is configured or determined to determine the UL transmission mode based on transmissions and network indications. In some examples, the WTRU may receive the sets of configurations, each including RS or transmission configuration for UL channel quality measurement (at the network side).

In an example, the WTRU may receive a first set of configurations corresponding to the relayed transmission configurations, and including RSs resources and parameters for the different transmission modes, e.g., low-power low-complexity, low-power high-complexity and MR. If the WTRU receives the indication that the WTRU is relayed, the WTRU uses the first set of configured RS/transmissions to perform the UL channel quality measurements. For example, the RS may be configured to target the relay WTRU, e.g., on WTRU-to-WTRU resources or using RS configured for inter-WTRU measurements.

In another example, the WTRU may receive a second set of configurations corresponding to the non-relayed transmission configurations, and including RSs resources and parameters for the different transmission modes, e.g., low-power low-complexity, low-power high-complexity and MR. If the WTRU receives the indication that the WTRU is not relayed, the WTRU uses the second set of configured RS/transmissions to perform the UL channel quality measurements.

The WTRU may then receive an indication from the network, indicating a transmission mode, associated with the transmitted RS/transmissions, similarly as described above.

The WTRU may be required to perform a transmission, for example, due to scheduled transmission/report or based on incoming UL traffic, the WTRU may activate the radio based on determined transmission mode. For example, the WTRU may activate the LP low-complexity mode, LP high-complexity mode, MR transmission mode, etc.

In an example embodiment, the WTRU may determine the associated transmission parameters, e.g., transmit power and resources, based on the transmission mode and based on whether the WTRU is relayed or not. For example, the WTRU may receive a first set of configuration for relayed transmission parameters, for each transmission mode, e.g., resources and transmit power, and a second set of configurations for non-relayed transmission parameters.

In an example, the transmission power of the relayed transmission parameters may be lower than the transmission power of the non-relayed transmission parameters. In some examples, the WTRU may receive an indication of a relayed transmission, and may use the transmission parameters in the first set of configurations for the different transmission modes. In some examples, the WTRU received an indication of a non-relayed transmission, and may use the transmission parameters in the first set of configurations for the different transmission modes.

The WTRU may then use the determined UL transmission mode and transmission parameters to perform the transmissions.

In an example embodiment, a WTRU may determine a procedure to choose an UL transmitter and an UL transmission mode based on the determined procedure.

A WTRU may receive one or more of configurations (e.g., via SIB and/or RRC) as described herein.

The WTRU may receive measurement related configurations. The measurement configurations may include: one or more LR measurement thresholds for determining an UL transmission mode (e.g., a first UL threshold and a second UL threshold where, the first UL threshold >the second UL threshold); one or more MR measurement thresholds for determining the UL transmission mode; one or more RSs for MR (e.g., SSBs); and one or more RSs for LR (e.g., LP-SSs), whether alone or in combination

The measurement configurations may include may resources for a first (e.g., low complexity) LP UL transmission mode (e.g., based on back scattering). The measurement configurations may include resources for a second (e.g., high complexity) LP UL transmission mode (e.g., sequence based). The measurement configurations may include resources for MR based UL transmission mode.

The WTRU may measures one or more RSs according to the activated receiver. For example, if the WTRU activated LR, the WTRU measures the one or more RSs for LR. In another example, if the WTRU activated MR, the WTRU measures the one or more RSs for MR.

The WTRU may determine an UL transmission mode based on the measurements. For example, if the DL measured quality>the first UL threshold, the WTRU determines the first LP UL transmission mode, if the DL measured quality>the second UL threshold, the WTRU determines the second LP UL transmission mode, and if the DL measured quality<the second UL threshold, the WTRU determines MR based UL transmission mode.

The WTRU may activate the determined UL transmission mode. The WTRU may activate the indicated UL transmission mode within an activation window associated with the activated UL transmission mode. Optionally, the WTRU may indicate the determined UL transmission mode (e.g., to the gNB). For example, if the first LP UL transmission mode is used or determined, the WTRU reflects all or a subset (e.g., associated with the transmitter and/or a best beam) of the one or more RSs for LR.

The WTRU may support operation based on a type of the activated UL transmission mode. For example, if the WTRU activates the first or the second LP UL transmission mode, the WTRU measures one or more RSs for LR (e.g., LP-SS) and reports CSI change, where the CSI change is reported as one or more of the following: no information change; information change less than a first CSI threshold; information change less than a second CSI threshold; and information change more than the second CSI threshold, either alone or in combination.

If the WTRU activates the first LP UL transmission mode, the WTRU reports the CSI change based on OOK or BPSK by reflecting the one or more RSs for LR. If the WTRU activates the second LP UL transmission mode, the WTRU reports the CSI change by transmitting a sequence in an UL resource of the one or more UL resources, wherein the sequence and/or the UL resource are associated with the CSI.

For the case of information change more than the second CSI threshold, the WTRU activates MR based UL transmission mode after an associated activation time from sending the indication. For example, the WTRU measures one or more RSs associated with MR (e.g., SSB) and reports CSI in UL resources for MR (e.g., within DRX on duration).

The techniques described enable a WTRU to stay in a low power state without waking up MR for UL transmissions allowing the WTRU to reduce power consumption.

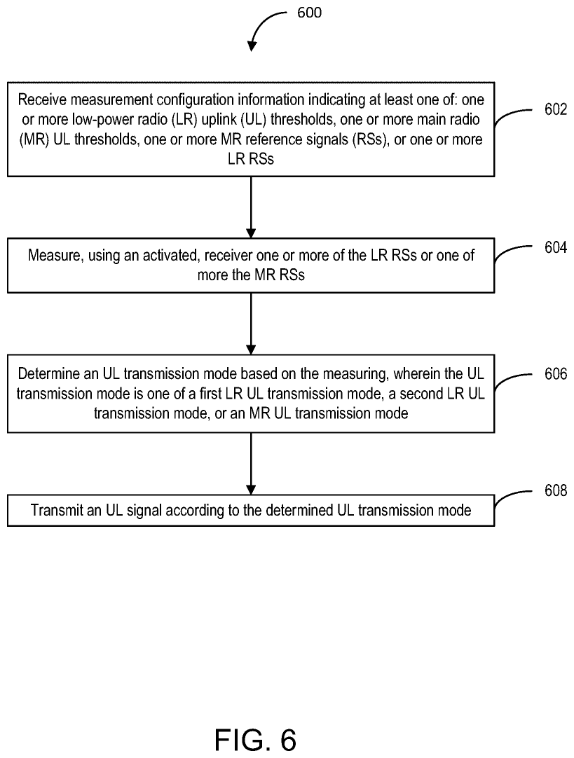

FIG. 6 is a flow diagram of an example process for choosing an UL transmitter and an UL transmission mode.

As shown in FIG. 6, process 600 may include, at 602, receiving a measurement configuration including at least one of: one or more low-power radio (LR) UL thresholds, one or more main radio (MR) UL thresholds, one or more MR reference signals (RSs), or one or more LR. For example, WTRU may receive a measurement configuration including at least one of: one or more LR UL thresholds, one or more MR UL thresholds, one or more MR RSs, or one or more LR RSs, as described above. As also shown in FIG. 6, process 600 may include, at 604, measuring one or more of the LR RSs or one of more the MR RSs based on an activated receiver. For example, the WTRU may measure one or more of the LR RSs or one of more the MR RSs based on an activated receiver, as described above. As further shown in FIG. 6, process 600 may include, at 606, determining an UL transmission mode based on the measuring, where the UL transmission mode is one of a first LR UL transmission mode, a second LR UL transmission mode, or a MR UL transmission mode. For example, the WTRU may determine an ul transmission mode based on the measuring, where the ul transmission mode is one of a first LR ul transmission mode, a second LR ul transmission mode, or a MR ul transmission mode, as described above. As also shown in FIG. 6, process 600 may include, at 608, transmitting an UL signal according to the determined UL transmission mode. For example, the WTRU may transmit an ul signal according to the determined ul transmission mode, as described above.

Process 600 may include additional implementations, such as any single implementation or any combination of implementations described below and/or in connection with one or more other processes described elsewhere herein. A first implementation, process 600 further includes receiving at least one of: first configured resources for the first LR UL transmission mode; second configured resources for the second LR UL transmission mode; or third configured resources for the MR UL transmission mode.

A second implementation, alone or in combination with the first implementation, process 600 further includes determining a type of channel state information (CSI) based on the UL signal transmitted.

A third implementation, alone or in combination with the first and second implementation, process 600 further includes measuring the one or more LR RSs when the transmitted UL signal may include the first LR UL transmission mode or the second LR UL transmission mode; and reporting CSI change information, where the CSI change information is one of: no change, a change less than a first CSI threshold, a change less than a second CSI threshold, or a change more than the second CSI threshold.

A fourth implementation, alone or in combination with one or more of the first through third implementations, process 600 may include reporting the CSI change information based on on-off keying or binary phase shift keying (BPSK) by reflecting one or more of the first configured resources when the UL signal is transmitted via the first LR UL transmission mode.

A fifth implementation, alone or in combination with one or more of the first through fourth implementations, process 600 further includes transmitting a sequence using an UL resource of the second configured resources to report the CSI change information when the UL signal is transmitted via the second LR UL transmission mode.

A sixth implementation, alone or in combination with one or more of the first through fifth implementations, process 600 further includes determining a DL signal quality based on the measuring.

A seventh implementation, alone or in combination with one or more of the first through sixth implementations, process 600 further includes determining the UL transmission mode is the first LR UL transmission mode when the determined DL signal quality is equal to or greater than a first LR UL threshold of the one or more LR UL thresholds; determining the UL transmission mode is the second LR UL transmission mode when the determined DL signal quality is equal to or greater than a second LR UL threshold of the one or more LR thresholds, where the first LR UL threshold is greater than the second LR UL threshold; and determining the UL transmission mode is the MR UL transmission mode when the determined DL signal quality is equal to or less than the second LR UL threshold.

In an eighth implementation, alone or in combination with one or more of the first through seventh implementations, the one or more MR RSs include at least one of a synchronization signal block (SSB) or channel state information reference signal (CSI-RS), and where the one or more LR RSs include at least one of a low-power synchronization signal (LP-SS) or an on-off key (OOK) based signal.

In a ninth implementation, alone or in combination with one or more of the first through eighth implementations, the UL signal is transmitted within an activation window associated with the determined UL transmission mode.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

In an embodiment, WTRU may determine to perform an initial access procedure with low power UL transmitter based on the determined procedure.

In an example, a WTRU is configured with a Main radio (MR) and a low power receiver and transmitter (LR). The WTRU may receive a configuration message for initial access procedure with LR (e.g., Low complexity UL transmission). The configuration may comprise one or more thresholds. The WTRU measures DL signal and (CW) Carrier Wave for backscattering. If measure DL-RSRP is above the first threshold (e.g., entry condition), the WTRU determines to monitor DL-signal via LR. Otherwise (e.g., if measure DL-RSRP is below the first threshold), the WTRU determines to perform initial access procedure via MR.

If a measured value of a received CW is above the second threshold (e.g., backscattering condition), the WTRU may determine to perform initial access procedure via LR (e.g., activate LR transmission based on backscattering).

If the measured LP-RSRP/RSRQ value is above the third threshold (e.g., condition for 2-step via LR); the WTRU may determine to perform 2-step initial access procedure and transmit the first message via LR. Otherwise (e.g., if measured LP-RSRP value is below the third threshold), the WTRU determines to perform 4-step initial access procedure and transmit the first message via LR.

If the measured CW for backscattering is below the second threshold or detecting the CW for backscattering is not available, the WTRU may determines to perform initial access procedure via LR (e.g., transmitting based on active transmission if supported).

In another example embodiment, a WTRU is configured with multiple UL transmitters, including at least one low-power/low-complexity transmitter and one high-power/high-complexity transmitter. The WTRU may determine which transmitter to use for a transmission based on whether another WTRU is relaying its transmissions (and based on, e.g., measurements). The WTRU may receive indications to know whether it is being relayed or not, e.g., using LP-based indications, and determine which configuration to use.

A WTRU may indicate the WTRU capability on multiple UL transmitter (e.g., one or more of low complexity UL transmitter, high complexity UL transmitter and MR based UL transmitter) and/or multiple DL receivers (e.g., one or more of OOK based LR, OFDM based LR and MR).

The WTRU may receive two or more of the following set of configurations (e.g., via SIB or RRC), e.g., a first set of configuration for relayed LP UL transmissions, a second set of configuration for non-relayed LP UL transmissions.

Measurement related configurations may include: one or more LR measurement thresholds for determining an UL transmission mode (e.g., a first UL threshold>a second UL threshold); one or more MR measurement thresholds for determining an UL transmission mode; one or more RSs for MR (e.g., RS from the network or from the relay WTRU); one or more RSs for LR (e.g., LP-RS from the network or from the relay WTRU).

Configuration information may include transmission configurations for the different UL transmission modes, e.g.: resources for low complexity UL transmission(e.g., based on back scattering); resources and transmit power for high complexity UL transmission (e.g., sequence based); and resources and transmit power resources for MR transmissions.

The WTRU may receive an indication from the network about which set of configurations to use for determining the UL transmission mode, e.g., including at least an index of which configuration to use (e.g., a binary indication if two sets of configurations are indicated by the network). If the WTRU activated LR, the WTRU receives a LP signal indicating the (change in) configuration, e.g. to use the LP-relayed configuration. If the WTRU activated MR, the WTRU receives a configuration update from the network, e.g., using RRC reconfiguration message.

If the WTRU received the indication to use the LP UL relayed configuration the WTRU measures one or more RSs according to the activated receiver and based on the RS of the LP UL relayed configuration. For example, if the WTRU activated LR, the WTRU measures the one or more RSs for LR using the first set of configurations. In another example, if the WTRU activated MR with relay, the WTRU measures the one or more RSs for MR using the first set of configurations

The WTRU may determine an UL transmission mode based on the measurements and based on the indication of LP UL relayed configuration. If the DL measured quality>the first UL threshold of the first set of configuration, the WTRU activates low complexity UL transmission mode. If the DL measured quality>the second UL threshold of the first set of configuration, the WTRU activates high complexity UL transmission mode. If the DL measured quality<the second UL threshold of the first set of configuration, the WTRU activates MR based UL transmission mode.

The WTRU may activate the determined UL transmitter. The WTRU transmits an UL signal in one or more UL resources associated with the activated UL transmitter based on the LP UL relayed configuration. If the WTRU activated the low complexity UL transmission mode, the WTRU transmits on the UL resources for low complexity UL transmission of the first set of configurations. If the WTRU activated the high complexity UL transmission mode, the WTRU transmits on the UL resources for high complexity UL transmission of the first set of configurations. If the WTRU activated the MR transmission mode, the WTRU transmits on the UL resources for MR transmission of the first set of configurations

In an embodiment, if the WTRU received the indication to use the non-LP UL relayed configuration, the WTRU measures one or more RSs according to the activated receiver and based on the RS of the non-LP UL relayed configuration. For example, if the WTRU activated LR, the WTRU measures the one or more RSs for LR using the second set of configurations. In another example, if the WTRU activated MR, the WTRU measures the one or more RSs for MR using the second set of configurations.

The WTRU may determine an UL transmission mode based on the measurements and based on the non-LP UL relayed configuration. If the DL measured quality>the first UL threshold of the second set of configuration, the WTRU activates low complexity UL transmission mode. If the DL measured quality>the second UL threshold of the second set of configuration, the WTRU activates high complexity UL transmission mode. If the DL measured quality<the second UL threshold of the second set of configuration, the WTRU activates MR based UL transmission mode.

The WTRU may activate the determined UL transmitter, and the WTRU may transmit an UL signal in one or more UL resources associated with the activated UL transmitter based on the non-LP UL relayed configuration. If the WTRU activated the low complexity UL transmission mode, the WTRU transmits on the UL resources for low complexity UL transmission of the second set of configurations. If the WTRU activated the high complexity UL transmission mode, the WTRU transmits on the UL resources for high complexity UL transmission of the second set of configurations. If the WTRU activated the MR transmission mode, the WTRU transmits on the UL resources for MR transmission of the second set of configurations

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed by a wireless transmit/receive unit (WTRU), the method comprising:
receiving measurement configuration information indicating at least one of: one or more low-power radio (LR) uplink (UL) thresholds, one or more main radio (MR) UL thresholds, one or more MR reference signals (RSs), or one or more LR RSs;
measuring, using an activated receiver, one or more of the LR RSs or one of more the MR RSs;
determining an UL transmission mode based on the measuring, wherein the UL transmission mode is one of a first LR UL transmission mode, a second LR UL transmission mode, or an MR UL transmission mode; and
transmitting an UL signal according to the determined UL transmission mode.

2. The method of claim 1, further comprising: receiving at least one of: first configured resources for the first LR UL transmission mode; second configured resources for the second LR UL transmission mode; or third configured resources for the MR UL transmission mode.

3. The method of claim 1, further comprising: determining a downlink (DL) signal quality based on the measuring.

4. The method of claim 3, further comprising:
determining the UL transmission mode is the first LR UL transmission mode when the determined DL signal quality is equal to or greater than a first LR UL threshold of the one or more LR UL thresholds;
determining the UL transmission mode is the second LR UL transmission mode when the determined DL signal quality is equal to or greater than a second LR UL threshold of the one or more LR thresholds, wherein the first LR UL threshold is greater than the second LR UL threshold; and
determining the UL transmission mode is the MR UL transmission mode when the determined DL signal quality is equal to or less than the second LR UL threshold.

5. The method of claim 2, further comprising: determining a type of channel state information (CSI) based on the UL signal transmitted.

6. The method of claim 5, further comprising:
measuring the one or more LR RSs when the transmitted UL signal comprises the first LR UL transmission mode or the second LR UL transmission mode; and
reporting CSI change information, wherein the CSI change information is one of: no change, a change less than a first CSI threshold, a change less than a second CSI threshold, or a change more than the second CSI threshold.

7. The method of claim 6, further comprising reporting the CSI change information based on on-off keying or binary phase shift keying (BPSK) by reflecting one or more of the first configured resources when the UL signal is transmitted via the first LR UL transmission mode.

8. The method of claim 6, further comprising: transmitting a sequence using an UL resource of the second configured resources to report the CSI change information when the UL signal is transmitted via the second LR UL transmission mode.

9. The method of claim 1, wherein the one or more MR RSs include at least one of a synchronization signal block (SSB) or channel state information reference signal (CSI-RS), and wherein the one or more LR RSs include at least one of a low-power synchronization signal (LP-SS) or an on-off key (OOK) based signal.

10. The method of claim 1, wherein the UL signal is transmitted within an activation window associated with the determined UL transmission mode.

11. A wireless transmit/receive unit (WTRU) comprising:
processor circuitry; and
a plurality of radios including at least one of: a first low-power radio (LR), a second LR, or a main radio (MR), wherein one or more of the plurality of radios are configured to receive a measurement configuration including at least one of: one or more low-power radio (LR) UL thresholds, one or more main radio (MR) UL thresholds, one or more MR reference signals (RSs), or one or more LR RSs;
the processor circuitry configured to:
measure one or more of the LR RSs or one or more of the MR RSs based on a respective radio of the plurality of radios;
determine an UL transmission mode based on the measured one or more the LR RSs or one or more the MR RSs, wherein the UL transmission mode is one of a first LR UL transmission mode, a second LR UL transmission mode, or a MR UL transmission mode; and
activate a respective radio of the plurality of radios based on the determined UL transmission mode, wherein the respective radio is configured to transmit an UL signal.

12. The WTRU of claim 11, wherein one or more the plurality of radios are configured to receive at least one of: first configured resources for the first LR UL transmission mode, second configured resources for the second LR UL transmission mode, or third configured resources for the MR UL transmission mode.

13. The WTRU of claim 12, wherein the processor circuitry is further configured to determine a DL signal quality based on the measured one or more the LR RSs or one of more the MR RSs.

14. The WTRU of claim 13, wherein the processor circuitry is further configured to:
determine the UL transmission mode is the first LR UL transmission mode when the determined DL signal quality is equal to or greater than a first LR UL threshold of the one or more LR UL thresholds;
determine the UL transmission mode is the second LR UL transmission mode when the determined DL signal quality is equal to or greater than a second LR UL threshold of the one or more LR thresholds, wherein the first LR UL threshold is greater than the second LR UL threshold; and
determine the UL transmission mode is the MR UL transmission mode when the determined DL signal quality is equal to or less than the second LR UL threshold.

15. The WTRU of claim 14, wherein the processor circuitry is further configured to determine a type of channel state information (CSI) based on the UL signal transmitted.

16. The WTRU of claim 15, wherein the processor circuitry is further configured to measure the one or more LR RSs when the transmitted UL signal comprises the first LR UL transmission mode or the second LR UL transmission mode, and wherein the first LR or the second LR is configured to report CSI change information, wherein the CSI change information is one of: no change, a change less than a first CSI threshold, a change less than a second CSI threshold, or a change more than the second CSI threshold.

17. The WTRU of claim 16, wherein the UL transmission mode is the first LR UL transmission mode and the first LR is configured to report the CSI change information based on on-off keying or binary phase shift keying (BPSK) by reflecting one or more of the first configured resources when the UL signal is transmitted via the first LR UL transmission mode.

18. The WTRU of claim 16, wherein the UL transmission mode is the second LR UL transmission mode and second LR transmits a sequence via an UL resource of the second configured resources to report the CSI change information.

19. The WTRU of claim 11, the one or more MR RSs comprise at least one of a synchronization signal block (SSB) or channel state information reference signal (CSI-RS), and wherein the one or more LR RSs include at least one of a low-power synchronization signal (LP-SS) or an on-off key (OOK) based signal.

20. The WTRU of claim 11, the plurality of radios are configured to transmit the UL signal within an activation window associated with the determined UL transmission mode.
